(19) United States
(12) Patent Application Publication
(10) Pub. No.: US 2018/0018683 A1
(43) Pub. Date: Jan. 18, 2018

(54) Demand Prediction for Time-Expiring Inventory

(71) Applicant: Airbnb, Inc., San Francisco, CA (US)

(72) Inventors: Yangli Hector Yee, San Francisco, CA (US); Li Zhang, Palo Alto, CA (US); Carla Pellicano, San Francisco, CA (US); Peng Ye, Foster City, CA (US)

(21) Appl. No.: 15/213,062

(22) Filed: Jul. 18, 2016

(51) Int. Cl. G06Q 30/02

(52) U.S. Cl. CPC G06Q 30/0202

(57) ABSTRACT

This disclosure includes methods for predicting demand based on the price of a time-expiring inventory. An online system provides a connection between a manager of a time-expiring inventory and a plurality of clients. The online system provides a listing for the manager's time-expiring inventory to clients on the online system. The manager specifies the price of the time-expiring inventory in the listing and is presented with price tips generated by the online system. A demand function predicts the demand for the time-expiring inventory based on features of the listing and the time-expiring inventory. A manager option function predicts the likelihood of acceptance of a price tip by the manager. The online system uses the demand function and the manager option function to create a Monte Carlo pricing model to provide to the manager price tips for the listing.

### TECHNICAL FIELD

This application relates generally to the use of machine learning models and data analysis in the context of time-expiring inventory, and particularly to the assignment of training labels to machine learning sample data relating to time-expiring inventory.

### BACKGROUND

In a typical transaction for a good or service, the manager that controls or owns the good sets the price of the good and waits for an interested party to agree to pay the proposed price. Oftentimes the manager fails to correctly price the good but because of incomplete information in the market and other economic factors someone may eventually agree to pay the price. However, pricing time-expiring inventories is a more challenging endeavor because if the inventory is not sold before it expires, the inventory is wasted and the manager receives no revenue. Thus, a manager of a time expiring inventory is susceptible to either pricing their inventory too high and risk losing revenue from expiration, or pricing their inventory too low and receiving suboptimal revenue but with good utilization. Additionally, the ideal or desired market-clearing price for a time-expiring inventory may change as the inventory approaches its expiration date. This combination of factors makes it difficult for a manager of a time-expiring inventory to optimally price their inventory.

### SUMMARY

An online system enables managers to create listings for time-expiring inventories and enables clients to submit a transaction request to reserve, lease, or buy a listed time-expiring inventory. The online system estimates demand for a listing of a time-expiring inventory and estimates the likelihood that a manager will price a listing over a range of prices. The online system defines a set of features that describe the time-expiring inventory, the associated listing, and the market for the time-expiring inventory. A set of these descriptive features is a feature vector for a listing. The online system estimates demand for a listing by inputting a feature vector of that listing into a demand function. The online system estimates the likelihood of manager to price the listing by inputting a feature vector into a manager option function. Depending on the embodiment the feature vector for the demand function may include a different set of features from the manager option function. Additionally, the manager option function may include features describing the manager in addition to features describing the listing.

The demand function is comprised of a feature model for each feature of the feature vector where each feature in the feature vector is associated with a feature model. The demand function may be a generalized additive model that sums the feature models to generate the demand estimate. The online system may train the demand function using training data where each sample from the training data comprises a binary label describing whether the time-expiring inventory of the listing received a transaction request from a client before it expired as well as a feature vector describing the listing of the time-expiring inventory at each sample time. The online system may collect a plurality of samples for a single listing where each sample corresponds to the features of the listing for the time-expiring inventory during a time period before the expiration of the time-expiring inventory.

The manager option model is created similarly to the demand model. Each feature of the feature vector has an associated feature model and those may be combined using a generalized additive model to generate an acceptance estimate correlated to a likelihood that a manager will choose to price a time-expiring inventory at a price given by a tip provided by the system. Although the features of both functions may overlap, the two functions use different training data and training labels. Each sample of training data for the manager option function with a positive label corresponds to a price that the manager has set for the time-expiring listing in the past for which the manager received a transaction. Negative training data for the manager option function is randomly generated between the lowest price set by the manager and a price of 0.

The online system then uses a likelihood model to convert the demand estimate to a likelihood of receiving a transaction request from a client. The online system uses a separate likelihood model to convert the acceptance estimate to a likelihood that the manager prices a listing at a given price. The online system may then create a price tip for the manager of a time-expiring inventory. The online system calculates the price tip by generating a set of test prices that are greater than or less than the current price of the time-expiring inventory. The online system then inputs, into the demand function, modified feature vectors of the listing of the time-expiring inventory each modified feature vector having a different test price. The same process is used to generate a number of test prices and modified feature vectors for the manager option model. The demand function and the manager option function each generate a set of test demand estimates and acceptance estimates, which the online system converts to a set of test likelihoods using the likelihood model.

The online system may fit a function based on the data points generated by the likelihood functions each data point comprised of a test likelihood and the corresponding test price that resulted in the test likelihood. The function fitted to the data points of the demand function represent a range of prices and the resulting predicted likelihoods of receiving a transaction request. The function fitted to the data points of the manager option function represents a range of prices and the resulting predicted likelihoods of the manager accepting a price tip at that price. Both likelihood versus price functions are then combined to create a cumulative likelihood function. The online system then makes creates a price tip using the cumulative likelihood function.

### BRIEF DESCRIPTION OF THE DRAWINGS

FIG. 1 is a block diagram of a computing environment including an online system that makes available time-expiring inventory for booking, in accordance with one embodiment.

FIG. 2 is a block diagram of the logical components of the online system in accordance with one embodiment.

FIGS. 3A-3C are diagrams illustrating the components and operation of the pricing module in accordance with one embodiment.

FIGS. 4A-4D illustrate labeling logic for training data used by the pricing module for the demand function in accordance with one embodiment.

FIG. 5A illustrates example stores for storing training data used by the pricing module for the demand function in accordance with one embodiment.

FIG. 5B illustrates example stores for storing training data used by the pricing module for the manager option function in accordance with one embodiment

FIG. 6 illustrates a feature model in accordance with one embodiment.

FIGS. 7A-7B illustrate example demand feature models in accordance with one embodiment.

FIGS. 7C-7D illustrate example manager option models in accordance with one embodiment.

FIG. 8A illustrates a demand likelihood model used by the pricing module in accordance with one embodiment.

FIG. 8B illustrates a manager option likelihood model used by the pricing module in accordance with one embodiment.

FIGS. 9A-9C illustrate the process of creating the demand model for a listing in accordance with one embodiment.

FIGS. 9D-9F illustrate the process of creating the manager option model for a listing in accordance with one embodiment.

FIG. 10 illustrates the creation of the Monte Carlo pricing model for a listing in accordance with one embodiment.

FIG. 11 is a conceptual illustration of an agility pricing strategy in accordance with one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

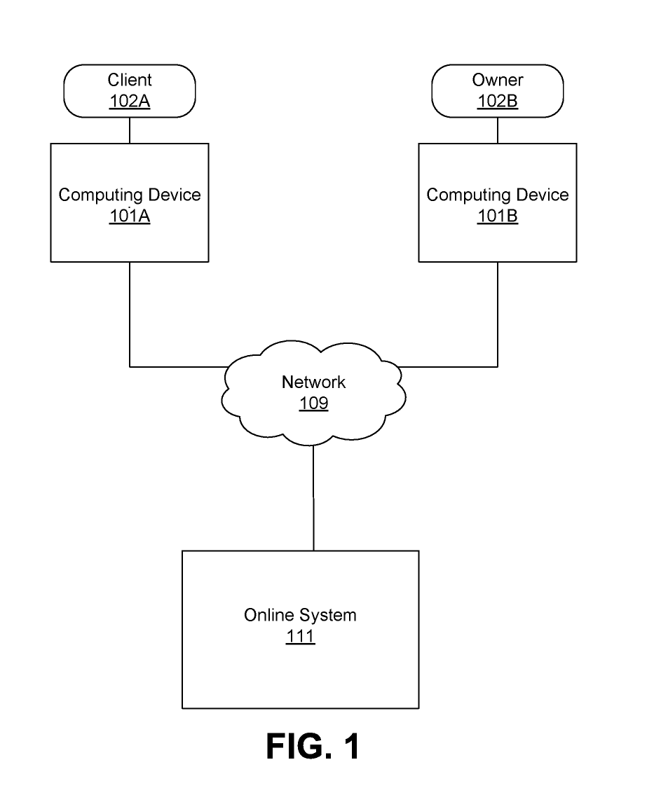

FIG. 1 is a block diagram of a computing environment including an online system for providing time-expiring inventory for purchase, rental, lease, reservation, etc. in accordance with one embodiment. The network 109 represents the communication pathways between one party to a transaction, herein referred to as clients 102A and the other party to the transaction, herein referred to as managers 102B.

For clarity of explanation, clients includes potential purchasers for value, renters, lessees, clients holding a reservation, or any other party providing consideration in exchange for access to, in whatever form, the time-expiring inventory. For clarity of explanation, managers includes the sellers of an item of time expiring inventory, landlords and property owners who manage property on behalf of the landlord, lessors, those managing reservation inventory such as ticket salesman or restaurant or hotel booking staff, or any other party receiving consideration in exchange for providing access (in whatever form) to the time expiring inventory. Depending upon the type of time-expiring inventory being transacted for, the time-expiring inventory may be being sold, leased, reserved, etc. For clarity of explanation, these different types of transactions are herein referred to as “bookings” to provide one convenient term for the whole set of possible types of transactions.

The online system 111 includes one or more computing devices that couples the computing devices 101 associated with the clients and managers across the network 109 to allow the clients and managers to virtually interact over the network 109. In one embodiment, the network is the Internet. The network can also utilize dedicated or private communication links (e.g. wide area networks (WANs), metropolitan area networks (MANs), or local area networks (LANs)) that are not necessarily part of the Internet. The network uses standard communications technologies and/or protocols.

The computing devices 101 are used by the clients and managers for interacting with the online system 113. A computing device 101 executes an operating system, for example, a Microsoft Windows-compatible operating system (OS), Apple OS X or iOS, a Linux distribution, or Google's Android OS. In some embodiments, the client device 101 may use a web browser 113, such as Microsoft Internet Explorer, Mozilla Firefox, Google Chrome, Apple Safari and/or Opera, as an user-friendly graphical interface with which to interact with the online system 111. In other embodiments, the computing devices 101 may execute a dedicated software application for accessing the online system 111.

The online system 111 provides a computing platform for clients and managers to interact via their computing devices 101 to transact for time-expiring inventory. The online system 111 may support, for example, a restaurant dining online system (or any other kind of online system such as a plane or train seat online system, a hotel online system or a day spa online system), a ride-share (carpool) online system, an accommodation online system, and the like.

The online system 111 provides managers with the ability to create listings for time-expiring inventory. A listing may be created for each individual instance of a time-expiring inventory, such as each seat for each plane for each flight offered by an airline online system. Alternatively, a listing may be created for a particular piece of inventory irrespective of time, and then the listing may be transacted for units of time that expire when those units of time have already passed. In this case, the listing is common to a set of time-expiring inventory, each item of time-expiring inventory in the set varying from the other only in the time/date ranges which is being transacted for. For example, for a real estate rental system, a listing may be for a particular apartment or condominium, and clients and managers may transact for different units of time (e.g., dates) associated with that apartment or condominium.

Generally, though not necessarily, each listing will have an associated real-world geographic location associated with the listing. This might be the location of a property for a rent, or a location of a restaurant for a reservation and possibly the specific table to be reserved. The online system 111 further provides managers with online software tools to help the managers manage their listings, which include providing information on actual and predicted demand for listings, as well as tips that empower managers with information they can opt to use to improve the utilization and/or revenue of a particular listing.

The online system provides clients with the ability to search for listings, communicate with managers regarding possible transactions, formally or informally request that a transaction take place (e.g., make an offer), and actually perform a transaction (e.g., buy, lease, reserve) with respect to a listing. The online system 111 comprises additional components and modules that are described below.

### II. Online System

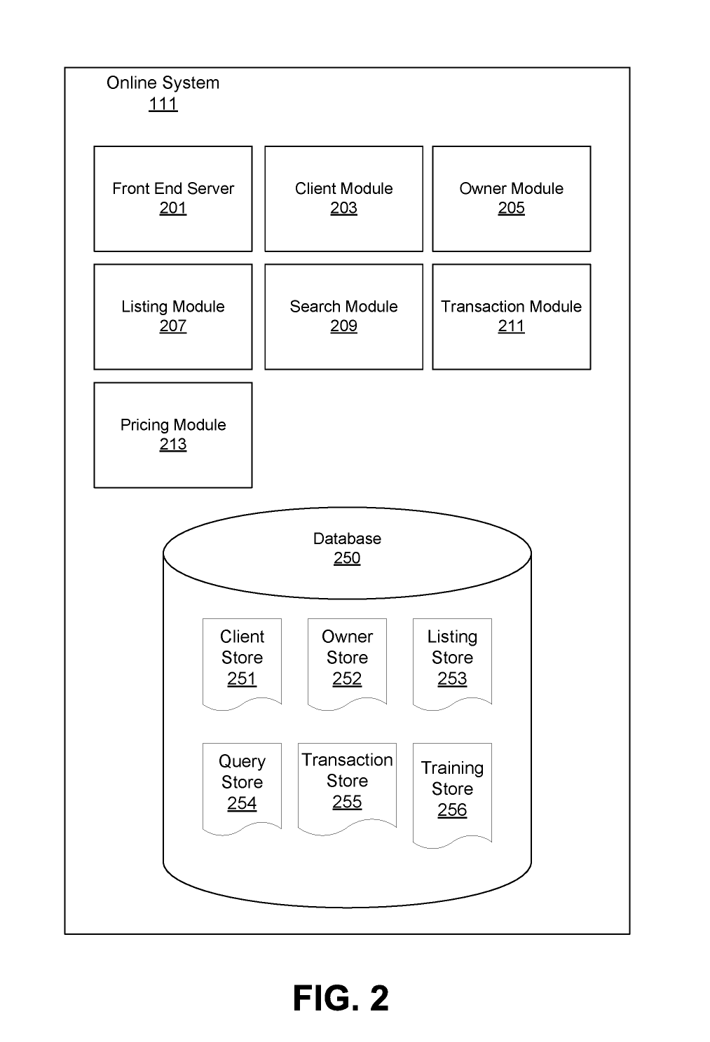

FIG. 2 is a block diagram of the logical components of the online system 111, in accordance with one embodiment. The online system 111 comprises a front end server 201, a client module 203, a manager module 205, a listing module 207, a search module 209, a transaction module 211, a pricing module 213, and a database 250. Those of skill in the art will further appreciate that the online system 111 may also contain different and other modules that are not described herein. In addition, conventional elements, such as firewalls, authentication systems, payment processing systems, network management tools, load balancers, and so forth are not shown as they are not directly material to the subject matter described herein.

The online system 111 may be implemented using a single computing device, or a network of computing devices, including cloud-based computer implementations. The computing devices are preferably server class computers including one or more high-performance computer processors and random access memory, and running an operating system such as LINUX or variants thereof. The operations of the online system 111 as described herein can be controlled through either hardware or through computer programs installed in non-transitory computer readable storage devices such as solid state drives or magnetic storage devices and executed by the processors to perform the functions described herein. The database 250 is implemented using non-transitory computer readable storage devices, and suitable database management systems for data access and retrieval. The online system 111 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

The database 250 includes a client data store 251, a manager data store 252, a listing data store 253, a query data store 254, a transaction data store 255, and a training data store 256. Those of skill in the art will appreciate that these data stores are not components of a generic database, and that database 250 may contain other data stores that are not explicitly mentioned here. The database may be implemented using any suitable database management system such as MySQL, PostgreSQL, Microsoft SQL Server, Oracle, SAP, IBM DB2, or the like.

The front end server 201 includes program code that client and manager computing devices 101 use to communicate with the online system 111, and is one means for doing so. The front end server 201 may include a web server hosting one or more websites accessible via a hypertext transfer protocol (HTTP), such that user agents such as web browser software applications that may be installed on the computing devices 101 can send commands and receive data from the online system. The front end server 201 may also make available an application programming interface (API) that allows software applications installed on the computing devices 101 to make calls to the API to send commands and receive data from the online system. The front end server 201 further includes program code to route commands and data to the other components of the online system 111 to carry out the processes described herein and respond to the computing devices 101 accordingly.

II.A Clients and Managers

The client module 203 comprises program code that allows clients to manage their interactions with the online system 111, and executes processing logic for client related information that may be requested by other components of the online system 111, and is one means for doing so. Each client is represented in the online system 111 by an individual client object having a unique client ID and client profile both of which are stored in client store 251. The client profile includes a number of client related attribute fields that may include a profile picture and/or other identifying information, a geographical location, and a client calendar. The client module 203 provides code for clients to set up and modify their client profile. The online system 111 allows each client to communicate with multiple managers. The online system 111 allows a client to exchange communications, requests for transactions, and transactions with managers.

The client's geographic location is either a client's current location (e.g., based on information provided by their computing device 101), or their manually-entered home address, neighborhood, city, state, or country of residence. The client location that may be used to filter search criteria for time-expiring inventory relevant to a particular client or assign default language preferences.

The manager module 205 comprises program code that provides a user interface that allows managers to manage their interactions and listings with the online system 111 and executes processing logic for manager related information that may be requested by other components of the online system 111, and is one means for doing so. Each manager is represented in the online system 111 by an individual manager object having a unique manager ID and manager profile, both of which are stored in manager store 252. The manager profile is associated with one or more listings owned or managed by the manager, and includes a number of manager attributes including transaction requests and a set of listing calendars for each of the listings managed by the manager. The manager module 205 provides code for managers to set up and modify their manager profile and listings. A user of the online system 111 can be both a manager and a client. In this case, the user will have a profile entry in both the client store 251 and the manager store 252 and represented by both a client object and manager object. The online system 111 allows a manager to exchange communications, responses to requests for transactions, and transactions with managers.

Any personally identifying information included as part of a client or manager profile, or that is transmitted to carry out a transaction is encrypted for user privacy and protection. For example, upon completion of a transaction by which a manager grants access to an accommodation and the client pays for such access, the transaction information is encrypted and stored as historical transaction information in database 250.

II.B Listings

The listing module 207 comprises program code for managers to list time expiring inventory for booking by clients, and is one means for doing so. The listing module 207 is configured to receive a listing from a manager describing the inventory being offered, a time frame of its availability including one or more of a start date, end date, start time, and an end time, a price, a geographic location, images and description that characterize the inventory, and any other relevant information. For example, for an accommodation online system, a listing includes a type of accommodation (e.g. house, apartment, room, sleeping space, other), a representation of its size (e.g., square footage, or number of rooms), the dates that the accommodation is available, and a price (e.g., per night, week, month, etc.). The listing module 207 allows the user to include additional information about the inventory, such as videos, photographs and other media.

Each listing is represented in the online system by a listing object which includes the listing's information as provided by the manager and a unique listing ID, both of which are stored in the listing store 253. Each listing object is also associated with the manager object for the manager providing the listing.

Regarding geographic location of a listing specifically, the location associated with a listing identifies the complete address, neighborhood, city, and/or country of the offered listing. The listing module 207 is also capable of converting one type of location information (e.g., mailing address) into another type of location information (e.g., country, state, city, and neighborhood) using externally available geographical map information.

Regarding the price of a listing specifically, the price is the amount of money a client needs to pay in order to complete a transaction for the inventory. The price may be specified as a one-time fee or an amount of money per day, per week, per day, per month, and/or per season, or other interval of time specified by the manager. Additionally, price may include additional charges such as, for accommodation inventory, cleaning fees, pet fees, service fees, and taxes.

Each listing object has an associated listing calendar. The listing calendar stores the availability of the listing for each time interval in a time period (each of which may be thought of as an independent item of time-expiring inventory), as specified by the manager or determined automatically (e.g., through a calendar import process). That is, a manager accesses the listing calendar for a listing, and manually indicates which time intervals that the listing is available for transaction by a client, which time intervals are blocked as not available by the manager, and which time intervals are already transaction for by a client. In addition, the listing calendar continues to store historical information as to the availability of the listing by identifying which past time intervals were booked by clients, blocked, or available. Further, the listing calendar may include calendar rules, e.g., the minimum and maximum number of nights allowed for the inventory. Information from each listing calendar is stored in the listing table 253.

II.C Search, Requests and Transactions

The search module 209 comprises program code configured to receive an input search query from a client and return a set of time-expiring inventory and/or listings that match the input query, and is one means for performing this function. Search queries are saved as query objects stored by the online system 113 in a query store 254. A query may contains a search location, a desired start time/date, a desired duration, a desired listing type, and a desired price range, and may also include other desired attributes of a listing. A potential client need not provide all the parameters of the query listed above in order to receive results from search module 209. The search module 209 provides a set of time-expiring inventory and/or listings in response to the submitted query that fulfill the parameters of the submitted query. The online system 111 may also allow clients to browse listings without submitting a search query in which case the viewing data recorded will only indicate that a client has viewed the particular listing without any further details from a submitted search query. Upon a client providing an input selecting a time-expiring inventory/listing to more carefully review for a possible transaction, the search module 209 records the selection/viewing data indicating which inventory/listings the client viewed. This information is also stored in the query data store 254.

The transaction module 211 comprises program code configured to enable clients to submit contractual transaction requests (also referred to as formal requests) to transact for time-expiring inventory, and is one means for performing this function. In operation, the transaction module 211 receives a transaction request from a client to transact for an item of time-expiring inventory, such as a particular date range for a listing offered by a particular manager. A transaction request may be a standardized request form that is sent by the client, which may be modified by responses to the request by the manager, either accepting or denying a received request form, such that the agreeable terms are reached between the manager and the client. Modifications to a received request may include, for example, changing the date, price, or time/date range (and thus, effectively, which time-expiring inventory is being transacted for), The standardized forms may require the client to record the start time/date, duration (or end time), or any other details that must be included for an acceptance to be binding without further communication.

The transaction module 211 receives the filled out form from the client and presents the completed request form including the booking parameters to the manager associated with the listing. The manager may accept the request, reject the request, or provide a proposed alternative that modifies one or more of the parameters. If the manager accepts the request (or if the client accepts the proposed alternative), then the transaction module 211 updates an acceptance status associated with the request and the time-expiring inventory to indicate that the request was accepted. The client calendar and the listing calendar are also updated to reflect that the time-expiring inventory has been transacted for a particular time interval. Other modules not specifically described herein then allow the client to complete payment, and for the manager to receive the payment.

The transaction store 254 stores requests made by clients, and is one means for performing this function. Each request is represented by request object. The request may include a timestamp, a requested start time, and a requested duration or a reservation end time. Because the acceptance of a booking by a manager is a contractually binding agreement with the client that the manager will provide the time expiring inventory to the client at the specified times, all of the information that the manager needs to approve such an agreement are included in a request. A manager response to a request is comprised of a value indicating acceptance or denial and a timestamp.

The transaction module 211 may also provide managers and clients with the ability to exchange informal requests to transact. Informal requests are not sufficient to be binding upon the client or manager if accepted, and in terms of content may vary from mere communications and general inquiries regarding the availability of inventory, to requests that fall just short of whatever specific requirements the online system 111 sets forth for a formal transaction request. The transaction module 211 may also store informal requests in the transaction store 254, as both informal and formal requests provide useful information about the demand for time-expiring inventory.

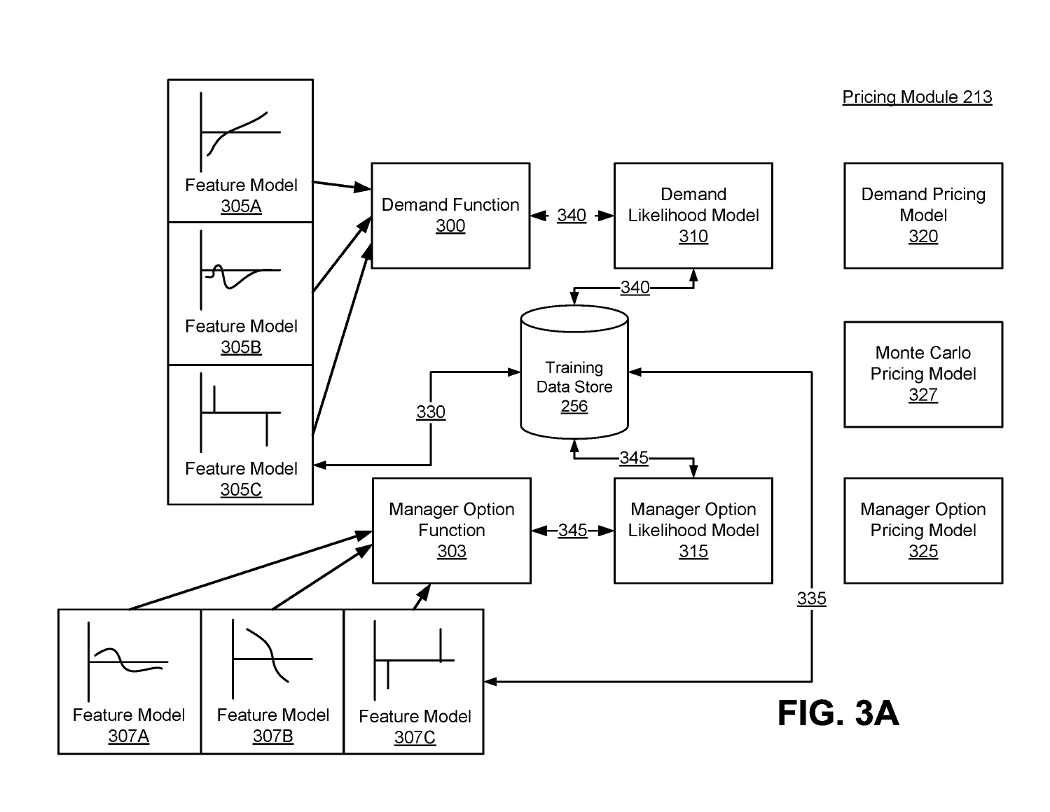

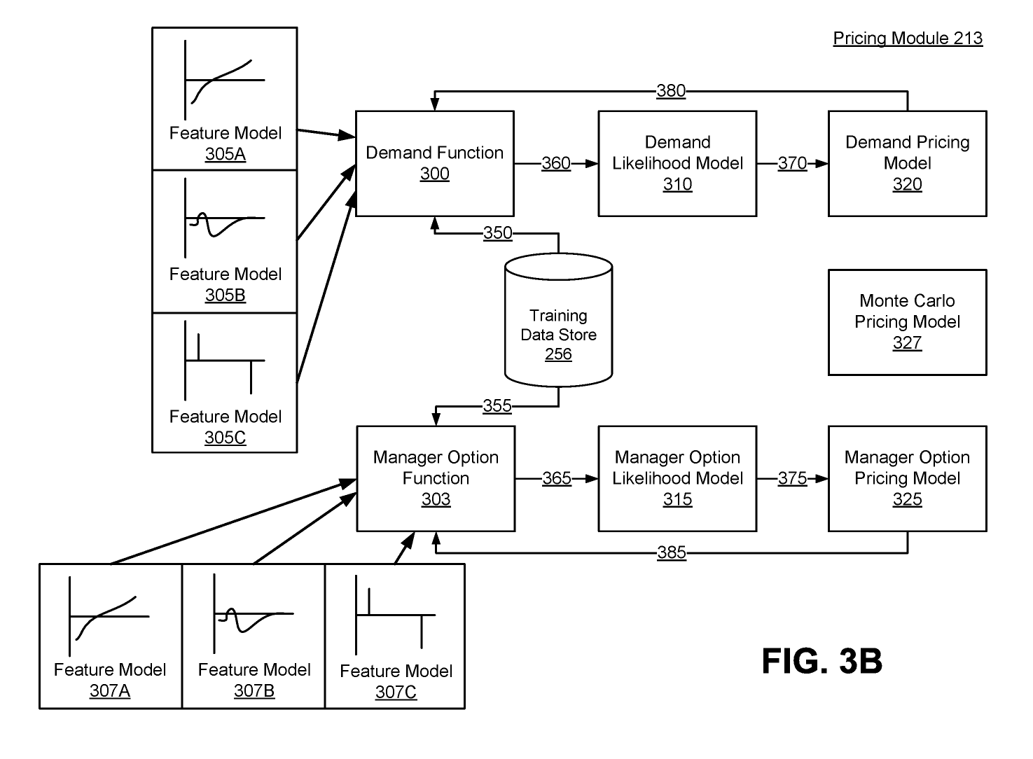

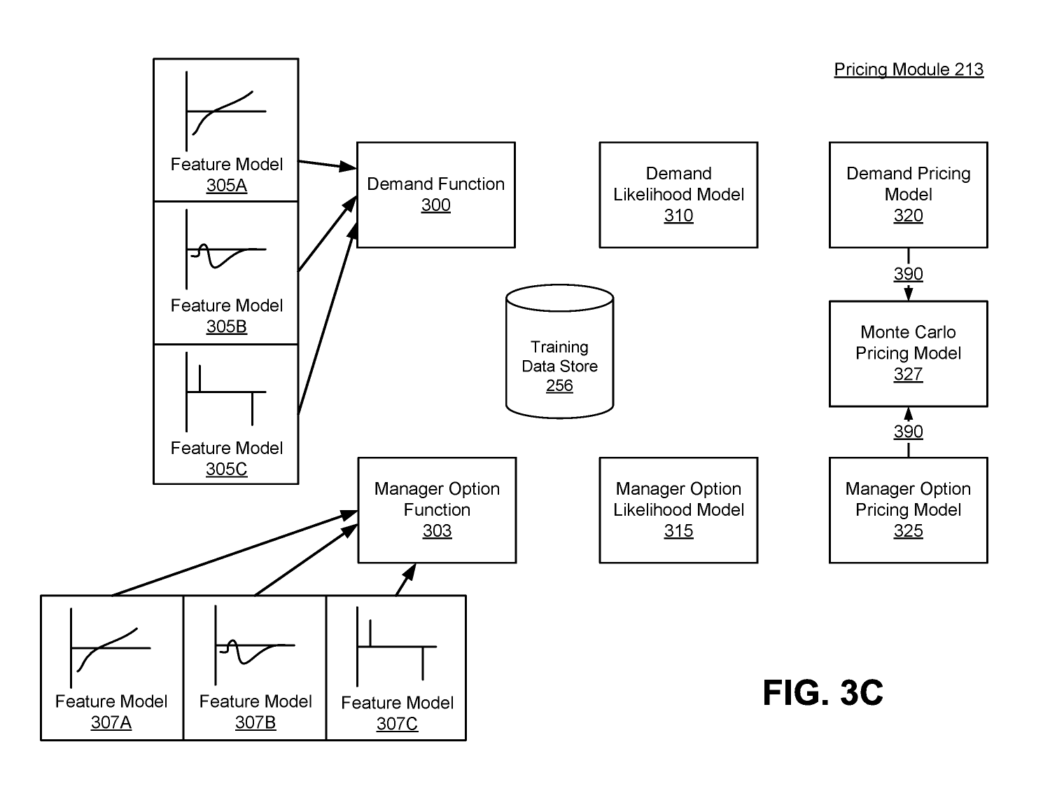

The pricing module 213 is described immediately below with respect to FIG. 3.

### III. Demand Prediction

III.A Overview

FIG. 3A is a flow diagram illustrating the components and operation of the pricing module in accordance with one embodiment. In order to create a price tip for the listing the pricing module 213 must estimate demand and the likelihood of acceptance at a number of potential prices. The models and functions representing the likelihood of acceptance of a listing at a given price for the manager of the listing are referred to as “manager option” models and functions as they estimate the likelihood of the manager of a listing exercising the option to accept or not accept a price tip provided by the system 111 by pricing the listing at the price indicated by the price tip.

In order to predict demand and acceptance for a time-expiring inventory in the online system 111, pricing module 213 uses a sequence of models and functions including multiple demand feature models 305, manager option feature models, a demand function 300, a manager option function 303, a demand likelihood model 310, a manager option likelihood model 315, a demand pricing model 320, a manager option pricing model 325, and a Monte Carlo pricing model 327.

The pricing module 213 trains the demand feature models 305 using a set of training data retrieved from the training store 256. The feature models 305 are used as part of a demand function 300 to determine a demand estimate for time-expiring inventory associated with listings in the listing store 223. The demand estimate may in practice be a unit-less numerical value, however the demand likelihood model 310 can use the demand estimate to determine the likelihood that a given time-expiring inventory will receive a transaction request prior to expiration. The demand pricing model 320 can make use of likelihoods generated by model 310 to predict the likelihood that time-expiring inventory will receive transaction requests at many different test prices, and therefore provide information about how changes in price (or any other feature from the feature models 305) are expected to shift the likelihood that the time expiring inventory receives a transaction request before expiration.

The pricing module 213 uses a similar process for the manager option component of the pricing algorithm. The pricing module trains 213 the manager option feature models 307 using manager option training data, which are then used as part of the manager option function 303. The manager option function 303 provides an unit-less estimate as to whether the manager of a listing will be willing to price a listing at a given price and with a given feature vector. The output of the manager option function 303 is then converted to a likelihood value by the manager option likelihood model 315. The manager option pricing model 325 can then predict the likelihood that a manager will accept a price tip for the listing at many different test prices. This provides information about how changes in price tips effect managers' decisions to accept price tips.

The pricing module 213 then creates a Monte Carlo pricing model 327 from the demand pricing model 320 and the manager option pricing model 325. The Monte Carlo demand model 327 combines both models to determine a price tip that is both likely to result in a listing receiving a transaction request and likely to be accepted by the manager of a listing.

The pricing module 213 operates on data regarding individual time-expiring inventory from associated listings, where listings are represented in the listing store 223 by a number of features. To predict demand, the pricing module 213 analyzes many of such inventory in aggregate, and the level of aggregation for demand analysis may vary by implementation. For example. the demand prediction may be system-wide, such that all data across all listings on the online system 111 are analyzed. Alternatively, smaller groupings of the data may be analyzed separately. For example, an online accommodation system may separately analyze the expected demand for all reservation listings in the Chicago metropolitan area, all reservation listings in the state of Kentucky, or all listings within a certain proximity to a national park. These localized estimates of demand are then used to predict demand in those specific locales. An equivalent process is also used to predict whether the manager will exercise the option to accept the price tip, thereby choosing to price the listing at the price included in the tip.

When discussing features, m represents the number of features that describe a listing, individual features are represented as f₁, f₂, f₃, . . . , fₘ, and the set of all features for the listing are represented by a feature vector f. The value of any given feature for a given listing may be a numerical value such as an integer, a floating point number, or a binary value, or it may be categorical. Common features include the price of the listing and the remaining time until the inventory expires. The demand function and the manager option function may utilize the same feature vector f or they may each operate on different sets of features f_{D} for the demand function and f_{A} for the manager option model. Some feature may be included in both f_{D} and f_{A}. For more information about the structure of individual instances of sample training data that are used to train the various functions and models, and also to use the pricing module 213 to obtain useful information about time-expiring inventory, see section III.C below.

The price feature is the price at which the listing is offered by the manager. For example, in the case of an online accommodation system, the value of the price feature would be the listed price for a client to book an accommodation on a particular day. The manager of a listing may change the price before the expiration time of the listing; therefore, a listing may have had multiple prices before it expires.

The time until expiration feature is defined as the number of time intervals or the duration of time before the expiration of the time-expiring inventory. Depending upon the implementation, this may be days hours, minutes, etc. Again using the example of an online accommodation system, the “expiration” of an individual time-expiring inventory would be the day the listing is sought to be booked. For example, a listing to reserve an accommodation on December 20^{th} would expire on December 20^{th}, therefore the value of the time until expiration feature would be the number of days from the current date until December 20^{th}. In this case, the time interval used is a day because bookings in an online accommodation system are typically made on a daily basis. However, in the case of an online restaurant booking system it might be preferable for the time interval to be an hour because restaurant bookings occur at a higher frequency and over narrower windows of time.

A listing of a time-expiring inventory in online system 111 may have any number of features in addition to the price and time until expiration features. These additional features are dependent on the implementation of the online system 111 and are descriptive of the time-expiring inventory or the listing. For example, in an online accommodation system a listing might have features representing the average client rating for a listed accommodation, the geographical location of the listed accommodation, the number of beds in the listed accommodation, whether the listed accommodation has a wireless router, or any other relevant attributes of the listed accommodation. Additionally, features may include qualities of the listing itself, for example, the number of views the listing has received, the length of the description of the accommodation in the listing, whether a request to book the listing will be reviewed by the manager of the listing before being accepted, or any other qualities of the online listing. Features of a listing may also include features describing manager attributes, for example, the rating of the manager, the length of the time the manager has been using the online system, etc.

Features may also include features that are relevant to the listing but are not directly related to the individual listing. These features may, for example, provide information about the state of the market for the listings related to a given item of inventory while that inventory was active (i.e., not yet expired or near in time to when it was expired). Examples of such features are the number of searches performed by clients on the online system 111 in the market for other inventory in the same market as the inventory. For example, in the case of an online accommodation system, the feature may be the number of searches for the day for accommodations in the San Francisco Noe Valley neighborhood in relation to an item of inventory located in that neighborhood. Another possible feature might be a binary feature indicating whether a noteworthy event (e.g., the Super Bowl) is occurring in sufficient proximity in time and geographic location to the inventory.

Additionally, a feature may describe an interaction between multiple other features or be derivative of other features. For example, the average price may be calculated for a listing between the time it was booked and the time it was listed. Alternatively, a feature might include a correlation value between the value of two other features.

The demand function 300 and manager option function 303 may be any function or statistical model that uses the feature values of listings to produce a demand estimate or an acceptance estimate, respectively. The demand estimate is a unitless value that is positively correlated with demand for a listing while the acceptance estimate is a similar unitless value that is instead positively correlated with the likelihood that the manager of a listing will except a price tip given input feature vectors. In one implementation the demand function and manager option function 303 are generalized additive models that are created by fitting the feature models for the features together to determine the contribution of that feature to the demand estimate or the acceptance estimate. A demand function 300 using a generalized additive model is of the form: D(f)=w₁(f₁)+w₂(f₂)+ . . . +wₘ(fₘ). Where D(f) is the function 300 and is also the output demand estimate, and w₁, w₂, . . . , wₘ are the weight functions of each of the feature models 305 that determine the contribution of each feature value f₁, f₂, . . . , fₘ, respectively to D(f). A manager option function of using a generalized additive model would be of the same form, for example A(f)=w₁(f₁)+w₂(f₂)+ . . . +wₘ(fₘ). The manager option model may also have different features as discussed above and in any case would have different weights than the demand function. The fitting of the generalized additive model may be completed using a number of fitting algorithms including stochastic gradient descent, kd-trees, Bayes, or a backfitting algorithm. These algorithms are used to iteratively fit the feature models 305 in order to reduce some loss function of the partial residuals between the feature models 305 and the labels on the training data of prior time-expiring inventory.

A demand feature model 305 may be any non-parametric statistical model relating a feature value to a weight indicative of the effect of the feature on the likelihood of the time-expiring inventory receiving a transaction request before expiration, which is related to the demand estimate D(f). Depending on the characteristics of each feature, a different statistical model may be fitted to each feature based on training data regarding possible values for that feature. For example, B-splines, cubic splines, linear fits, bivariate plane fits, piecewise constant functions, etc. may all be used. To define the features themselves, both supervised and unsupervised machine learning techniques may be used to determine the features at the outset prior to training of the generalized additive model. In the case of supervised learning techniques, the training may be based on some other signal other than the label of the training data, as that is instead used to train the generalized additive model. Likewise, manager option feature models 307 may be created in the same way using different training data and are instead given weights indicative of the effect of the feature on the likelihood of the manager to accept a price tip for a listing at a given price.

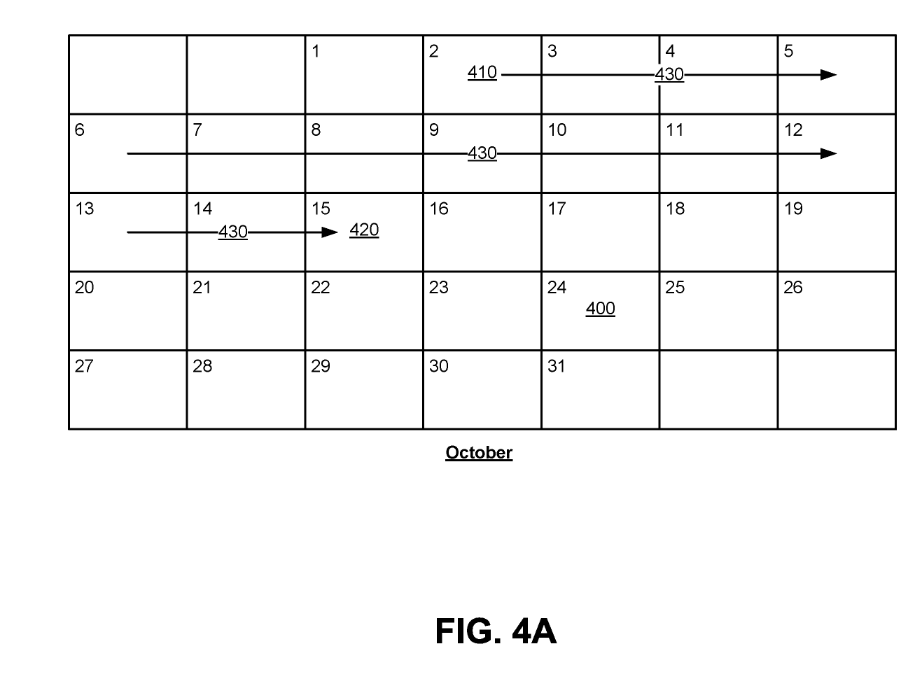

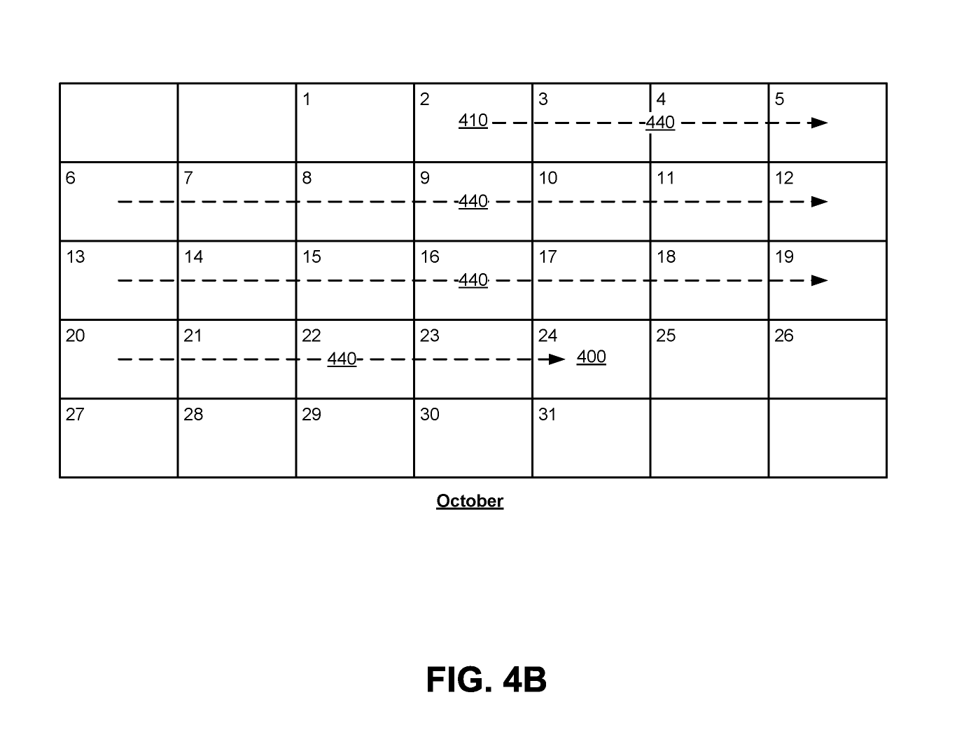

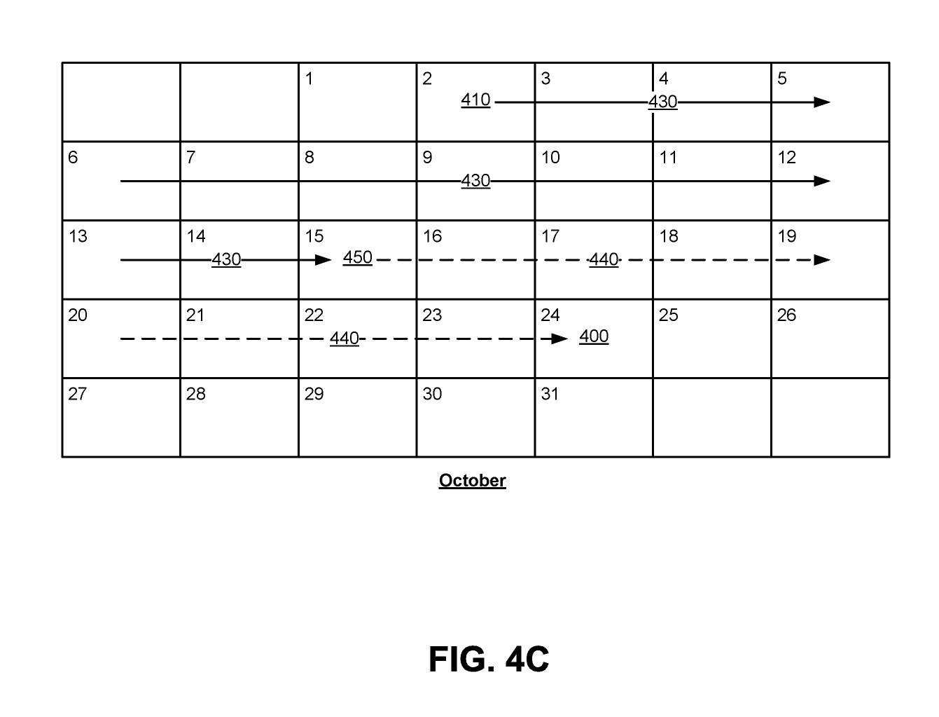

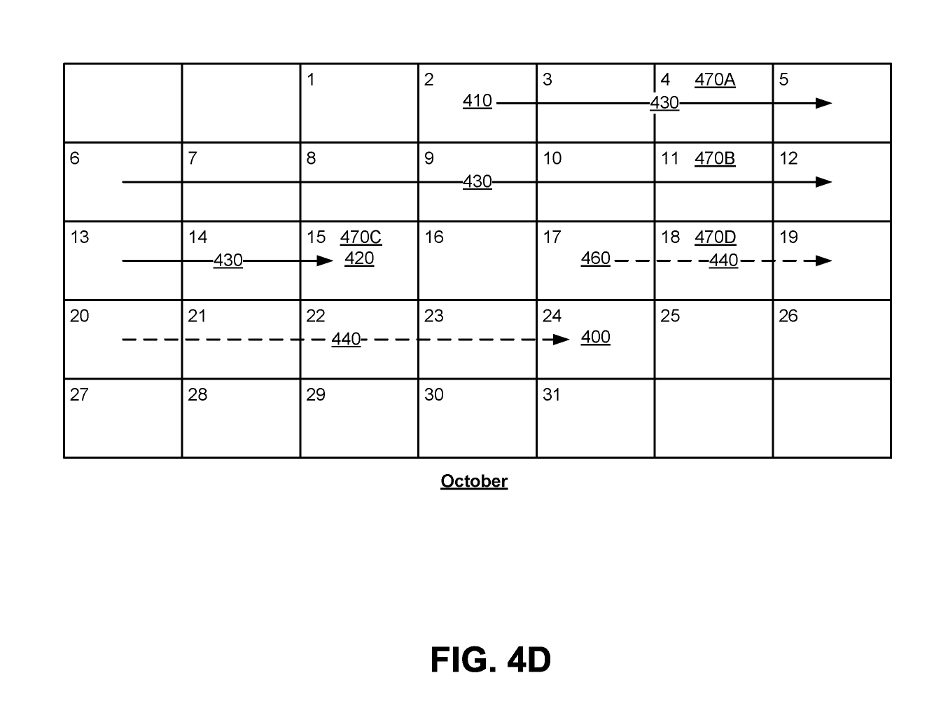

For demand training data, a positive label is assigned to a prior time-expiring inventory (herein referred to as a training time-expiring inventory) that received a transaction request from a client before expiration, and a negative label is assigned to a training time-expiring inventory that expired without receiving a transaction request. For manager option training data positive labels are assigned whenever a transaction is received for a listing at a given price. Negative labels are assigned to randomly generated pricing data, where the prices generated are below the lowest price associated with a positive training label. Further discussion of training data structure and training of feature models is provided in sections III.C and III.D, respectively, and with reference to FIGS. 4A-7D.

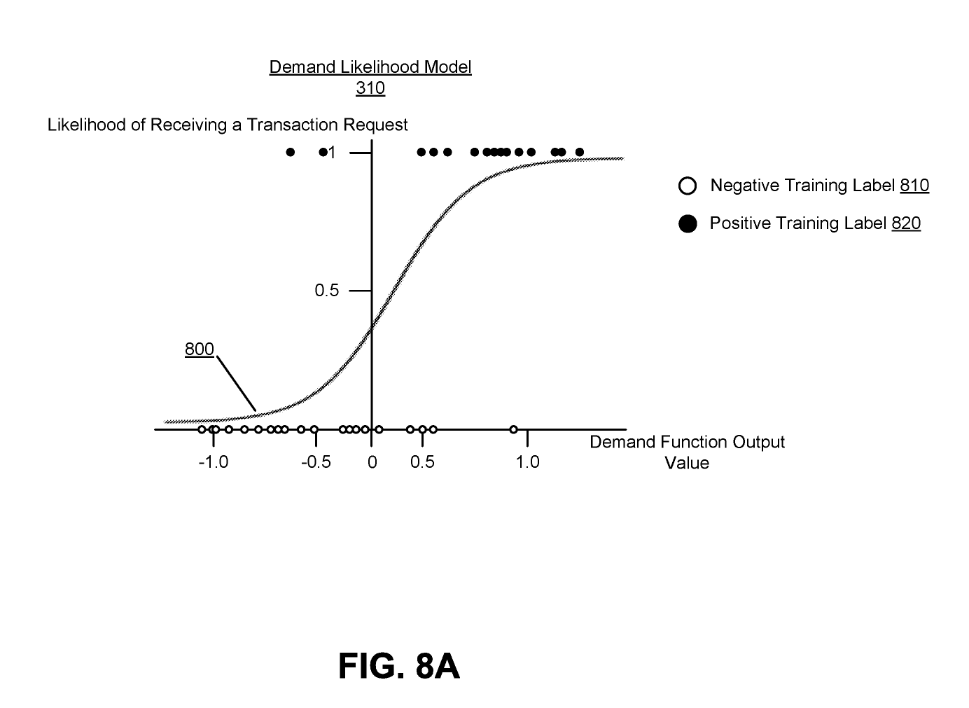

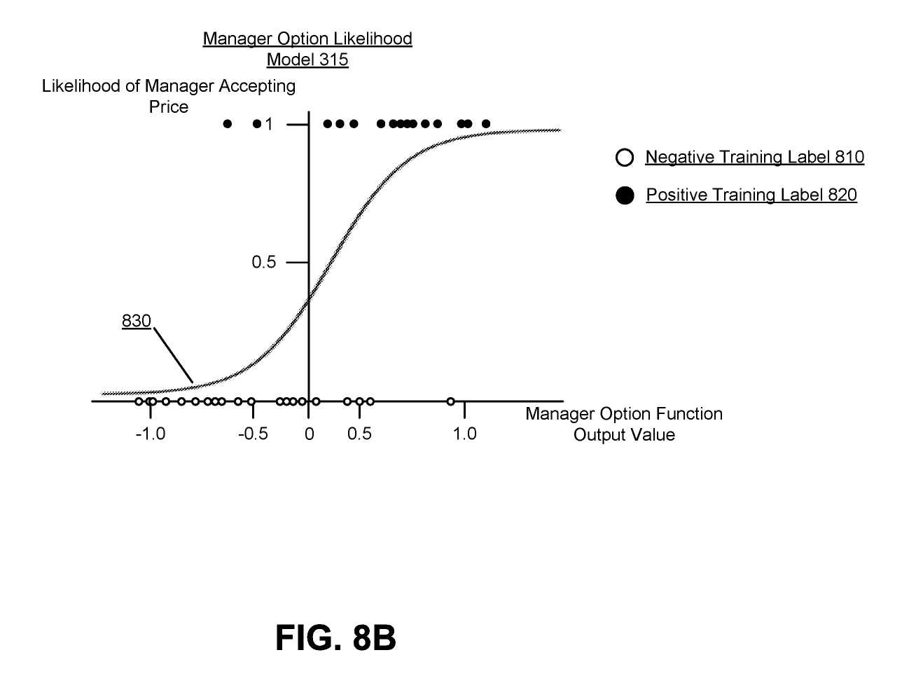

Returning to the demand estimate D(f), the demand estimate is a unit-less measure that is not actionable without verification using the training data. For example, a value for D(fₐ) for a particular feature vector fₐ might be 0.735. This information alone is not helpful without determining which values of the demand function 300 correspond with a likelihood of receiving a transaction request for a time-expiring inventory from a client before its expiration. The demand likelihood model 310 is a statistical model that solves this problem by mapping demand estimates, D(f), to the likelihood of receiving a transaction request, P(D(f)), given a listing with feature vector f. The demand likelihood model 310 is trained by using the same positive and negative training labels for each feature vector f used to train the demand function D(f). Further discussion of the demand likelihood model 310 is described in section III.E with reference to FIG. 8A. Likewise, the acceptance estimate A(f) produced by the manager option function 303 is not directly indicative of a likelihood of a manager accepting a price tip. Thus, an equivalent manager option likelihood model 315 P(A(f)) is developed and is described in section III. E with reference to FIG. 8B.

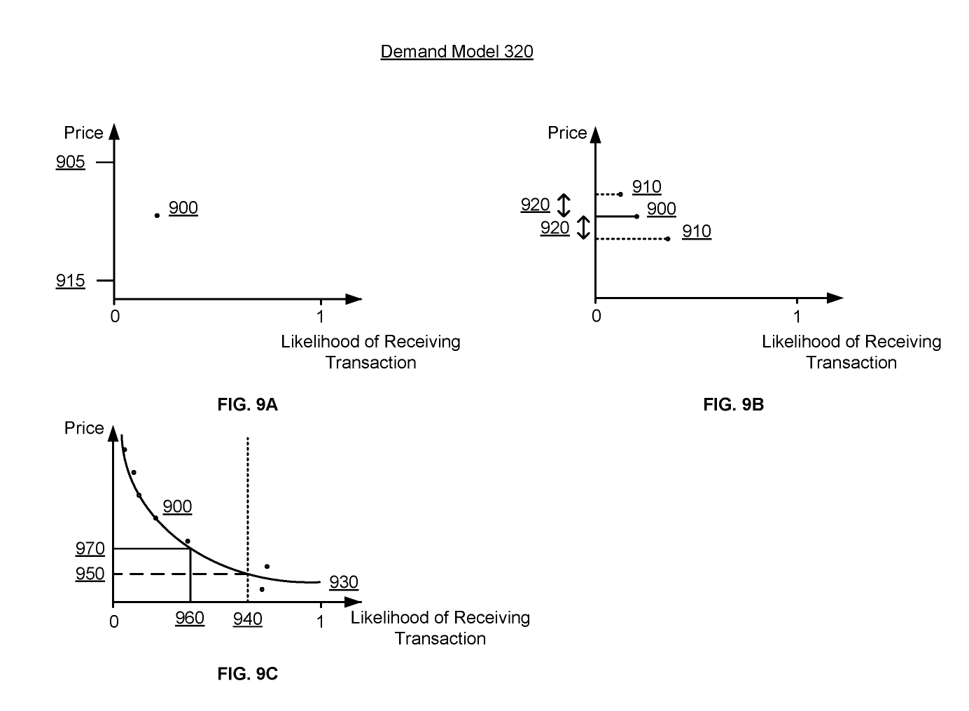

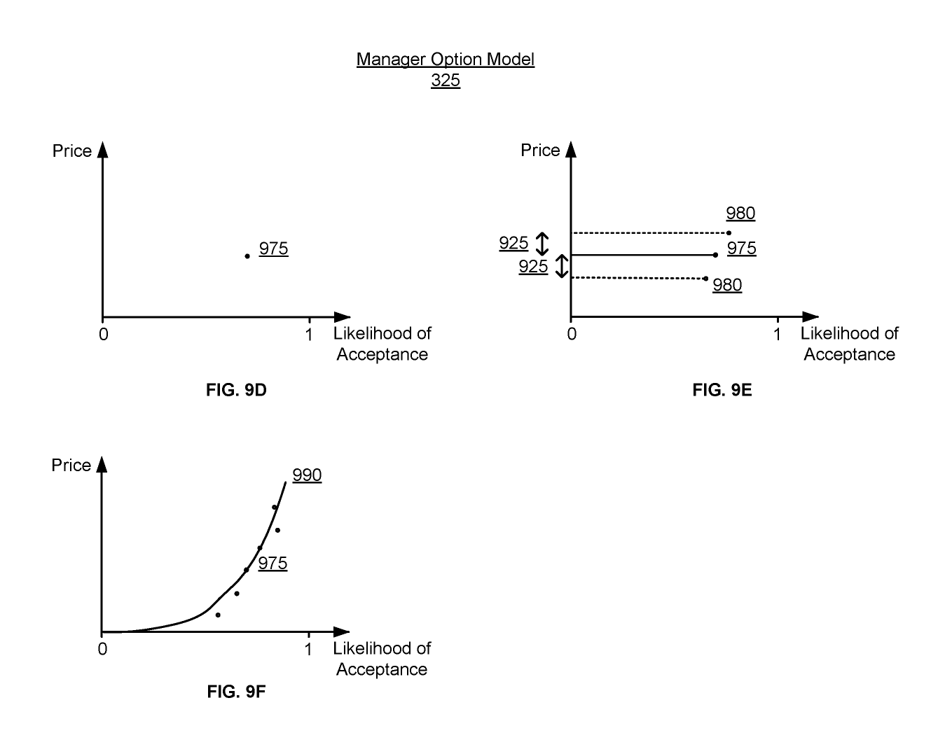

The demand pricing model 320 models the likelihood of receiving a transaction request for a listing at a variety of test prices around the listing's current price (or any other arbitrarily chosen price on request). The pricing module 213 uses an iterative process to generate the demand pricing model 320 that generates test data surrounding an initial data point representing the likelihood of receiving a transaction request at the listing's current price. The pricing module 213 utilizes the same process to create the manager option demand model 325, which models the likelihood of the manager accepting a price type at a variety of test prices. This process is outlined in section III. B below and is further described in section III. F with reference to FIG. 9.

III.B Example Process Flow

FIG. 3A also illustrates the process flow for training the demand function 300 and demand likelihood model 310 and the manager option function 303 and the manager option likelihood model 315 for a time expiring inventory according to the arrows between each of the models, functions and data stores in the figure. The pricing module 213 trains 330 and 335 the feature models 305 and 307 using the training data from training store 256. The pricing module 213 then evaluates the demand function 300 and the manager option function 303 for each feature vector of each sample in the training data and trains 340 and 345 the corresponding likelihood model 310 or 315 based on the label for each feature vector in each sample.

FIG. 3B illustrates the process of creating a model relating the price of a listing to the likelihood of it receiving a transaction request, or the demand pricing model 320, and the process of creating a model relating the price of a listing to the likelihood of the manager of the listing accepting a price tip at that price for the listing, or the manager option pricing model 325. The pricing module 213 creates the demand pricing model 320 and the manager option pricing model 325, after the pricing module 213 has trained the demand function 300 and the demand likelihood model 310 as well as the manager option function 303 and the manager option likelihood model 315. Upon receiving instructions from the online system 111 to predict the demand for a subject listing given the price of the listing, the pricing module 213 retrieves 350 the demand feature vector corresponding to the subject listing, fₛ, from the listing table 223 and uses it as an input to the demand function 300. The pricing module 213 then sends 360 the resulting demand estimate, D(fₛ), to the demand likelihood model 310 for conversion to a likelihood of receiving a transaction request prior to expiration. The pricing module 213 may then transfer 370 the resulting likelihood, P(D(fₛ)), to the demand pricing model 320 for use in modeling how changes in the pricing of a listing may alter demand for the listing.

To generate the demand pricing model 320, the pricing module 213 then modifies 380 the value of the price feature in the feature vector fₛ, by incrementing the price feature by a price interval in both the positive and negative directions creating test prices, thereby creating modified feature vectors fₛ⁽¹⁾ and fₛ⁽⁻¹⁾, which contain price feature value equal to each of the test prices. In the modified feature vectors, all other features values other than price are left unmodified. The likelihoods of receiving a transaction request for each of the new feature vectors, P(D(fₛ⁽¹⁾)) and P(D(fₛ⁽⁻¹⁾)), are then calculated by the demand function 300 and the likelihood model 310 and grouped with the original likelihood for the listing P(D(fₛ)). The pricing module 213 then continues incrementing the price feature by the price interval to create additional test prices for feature vectors fₛ⁽²⁾ and fₛ⁽⁻²⁾ and the process is repeated until enough data points are created to fit a monotonically decreasing function, which takes an input price and generates an output likelihood.

The pricing module 213 uses a process including steps 355, 365, 375, and 385, which roughly correspond to steps 350, 360, 370 and 380 respectively, to train the manager option demand model 325. Because managers are typically more likely to accept a tip if it indicates a higher price (likelihood of manager acceptance increases with price) a monotonically increasing function may be fit for the manager option demand model 325.

More specifically in step 355 the pricing module 213 retrieves 355 the manager option feature vector corresponding to the subject listing fₛ, from the listing table 223 and uses it as an input to the manager option function 303. The pricing module 213 then sends 365 the resulting acceptance estimate, A(fₛ), to the manager option likelihood model 315 for conversion to a likelihood of accepting a price tip for the listing at the price indicated in feature vector fs. The pricing module 213 may then transfer 375 the resulting likelihood P(A(fₛ)), to the manager option pricing model 325 for us in modeling how changes in the price of a listing displayed in a price tip may alter the likelihood that the manager accepts the price tip and therefore successfully prices the listing at the calculated price.

To generate the manager option pricing model 325, the pricing module 213 modifies 385 the value of the price feature in the feature vector fₛ by incrementing the price feature by a price interval in both the positive and negative directions creating test prices, thereby creating modified feature vectors fₛ⁽¹⁾ and fₛ⁽⁻¹⁾, which contain price feature value equal to each of the test prices. In the modified feature vectors, all other features values other than price are left unmodified. The likelihoods of acceptance for each of the new feature vectors, P(A(fₛ⁽¹⁾)) and P(A(fₛ⁽⁻¹⁾)), are then calculated by the manager option function 303 and the manager option likelihood model 315 and grouped with the original likelihood for the listing P(A(fₛ)). The pricing module 213 then continues incrementing the price feature by the price interval to create additional test prices for feature vectors fₛ⁽²⁾ and fₛ⁽⁻²⁾ and the process is repeated until enough data points are created to fit a monotonically decreasing function, which takes an input price and generates an output likelihood.

FIG. 3C illustrates the process of pricing a listing using the Monte Carlo pricing model 327. Upon reaching a threshold number of pricing points for both the demand pricing model 320 and the manager option demand model 325, the pricing module 213 combines 390 the two models into a cumulative likelihood model that represents both the likelihood of receiving a transaction request at a given price and the likelihood of the manager accepting a price tip at the given price. The cumulative model is referred to as a Monte Carlo demand model 327. The Monte Carlo demand model 327 may be used to identify a new tip for how to price a listing and/or achieve a certain likelihood of booking.

More generally, the ability of the pricing module 213 to generate a likelihood estimate based on demand provides information to the manager of the time-expiring inventory that the manager may take into account when selecting a price for the time-expiring inventory, while the likelihood based on the manager option allow the online system to generate more suitable price types to the manager.

III.C Training Data Labels

III.C.1 Training Data Collection

FIGS. 4A-4D illustrate the labeling logic for demand training data used by the pricing module 213 in accordance with one embodiment. In FIG. 4A a listing calendar is displayed having a time interval of one day. This means that a listing is only offered for booking by a client on a daily basis (though a client may request booking of a listing on multiple adjacent days). FIG. 4A illustrates how training data is sampled from historical booking data, which may be retrieved from the transaction store 255 and separately transferred to store 256 for use as training data. The timeline illustrated in FIG. 4A represents data taken from a single listing. The listing has an expiration time (or expiration date) 400 of October 24^{th}, an initial listing time (or initial listing date) 410 of October 2^{nd}, and a request received and accepted time (or date) of October 15^{th}.

The expiration time 400 of a listing is the time at which the time-expiring inventory is no longer available or presented to the client by the online system 111. In online reservation systems, the expiration time 400 is typically the time at which the reservation would begin.

The initial listing time 410 is the time at which the listing is first made available to clients and/or the first day that the listing was provided to the online system 111 by the manager.

The request received and accepted time 420 is the time at which a transaction request from a client has been both received and (formally) accepted by the manager, generally making the transaction contractually binding on both parties.

In the example of FIG. 4A, separate samples of training data are recorded 430 in the training store 256 for each day between the initial listing date 410 and the request received and accepted date 420. Each sample is comprised of a feature vector f for the listing on the day it was recorded. Labels for the samples are not applied until the final outcome of the listing is known. In the example of FIG. 4A, the samples for each of Oct. 2nd through Oct. 15th are given positive labels corresponding to an accepted request because the eventual outcome of the listing was a request and a subsequent acceptance of that request on the request received and accepted date 420.

In some embodiments, no samples are collected for the days between 420 and the expiration date 400 as the listing has already been accepted and is no longer being presented to clients on the online system 111. This may occur, for example, if the time-expiring inventory is unique. When a time expiring inventory is not unique (e.g., multiple approximately identical seats on a flight) the system may allow the listing to persist, and thus more data may be collected, during the time until the time expiring inventory is exhausted or expires. In some embodiments, the system defines multiple listings that share the same price and treats each non-unique listing as a unique listing which has a number of identical features. Bookings of a member of the group of listings are applied to one of the listings in the group and the rest of the listings are allowed to persist.

Recording a sample of training data for each time interval while the listing is available vastly increases the number of data points available to the pricing module 213 for analysis when compared to collecting only one data point for each accepted transaction request in aggregate over the total period of availability.

FIG. 4B illustrates a second example outcome for labeling samples of training data from a historical booking data. In the case illustrated in FIG. 4B the expiration date 400 and the initial listing date are the same as in FIG. 4A. However, in FIG. 4B no transaction requests were received for the listing even though the listing was available from the initial listing date 410 to the expiration date 400. As a result, all samples 440 obtained for the days that the listing was available are labelled with a negative training label indicating that a transaction request for the listing was not received before the time-expiring inventory expired.

Obtaining samples of training data for listings that have both received transaction request and also which have not received transaction requests and labeling them differently further increases the amount of data available to the pricing module 213 when compared to models that only take into account those listings that received transaction requests.

FIG. 4C illustrates a third more complicated example outcome for obtaining and labeling samples of training data from historical booking data. In FIG. 4C, the expiration date 400 and the initial listing date 410 are the same as in the two previous examples. However, in FIG. 4C the manager of the listing receives a transaction request on October 15^{th} but subsequently denies the request 450. This leaves the listing available to receive further transaction requests. No further transaction requests are received between the request denial date 450 and the expiration date.

In this situation, positive labels are applied 430 to samples for dates before the transaction request for the listing was received and subsequently rejected 450 as the request could have resulted in a successful transaction if the manager had accepted. Because the listing received no further transaction requests after the request denial date 450, samples for dates after the first request is labeled with a negative label 440, as the lack of transaction requests received during that period of time is independent of transaction requests received earlier in time, thus the features of the listing during that time period were unable to generate the demand sufficient to attract a transaction request. In some embodiments, the request denial date 450 may be the date that the denied transaction request was received. In other embodiments, the request denial date 450 is the date that the transaction request was denied. Alternatively (not shown) if a second transaction request is received after the first request was denied 450 the remaining samples would instead be labeled with a positive label.

FIG. 4D illustrates a fourth example outcome for obtaining and labeling samples of training data from historical booking data. In FIG. 4D, the expiration date 400 and the initial listing date 410 are again the same as in previous examples. As in FIG. 4A, a transaction request is received and accepted 420 on October 15^{th}, however in FIG. 4D the client that requested the listing cancels the transaction request allowing the listing to again be accessible to other clients on the online system 111. After being cancelled, the listing receives no further transaction requests. In a similar situation to FIG. 4C, the samples for dates from the initial listing date 410 to the transaction request acceptance date 420 are labelled 430 with a positive label and, after the listing is made available to clients on the cancellation date 460, the training data is labelled 440 with a negative label. In this case, the day in between the cancellation date 460 and the transaction request acceptance date 420 no samples are generated since the listing is not available to clients during that time. Again (not shown), if the listing had received a transaction request after cancellation date 460 the samples after the cancellation date would instead receive a positive label.

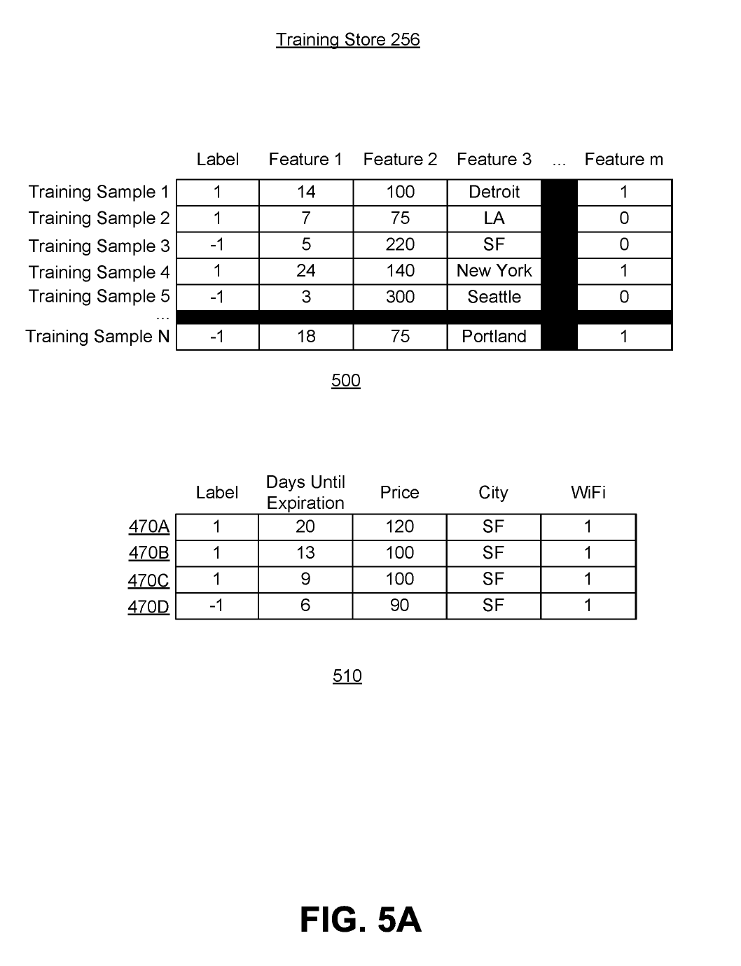

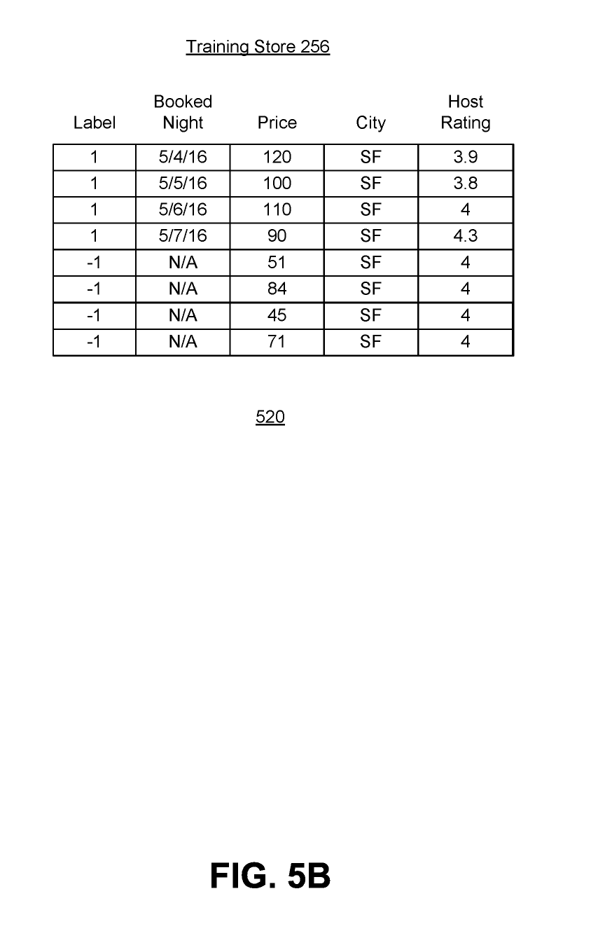

As above, individual demand training data samples are obtained on each date indicated by time periods 430 and 440, however samples 470A-470D are specifically labelled for use in the following discussion with reference to FIG. 5.

III.C.2 Demand Training Data Storage

FIG. 5A illustrates example tables for storing the demand training data used by the pricing module 213 in accordance with one embodiment. FIG. 5 displays two example tables for stored samples of training data table 500 and table 510. Table 500 is a general example indicating the variety of features that may be included in a feature vector, while table 510 is a specific example of samples 470 from a single listing that may be used in an accommodation system.

In table 500, each row represents a single sample of training data recorded for a particular day from historical booking data. Each row contains the feature value of each feature in the feature vector (f₁ through fₘ) and a training label that corresponds to the final outcome of the listing from which the training sample was recorded (as described with reference to FIG. 4A-4D). In this embodiment, a training label of 1 is used to represent that a transaction request was received for the listing and a training label of −1 is used to represent a situation in which no transaction request was received before the time-expiring inventory expired.

The columns of table 500 illustrate a number of example feature types: features 1 and 2 are quantitative, feature 3 is categorical, and feature m is binary. Table 500 contains m+1 columns (some of which are edited out for illustrative purposes) correspond to m features and the training label for each feature vector. Table 500 contains N rows corresponding to the total number of training data samples N.

Table 510 illustrates a selection of data sample from an example listing timeline illustrated in FIG. 4D. Though samples would be recorded for each day from the initial listing date 410 until the request acceptance data and again from the cancellation date 460 to the expiration date 400, only samples 470A-470D are shown in the table for discussion purposes and ease of illustration.

In table 510, the columns are labeled with example features for an online accommodation system listing including price, days until expiration, city of the listed accommodation, and whether the listed accommodation includes a wireless router (WiFi). Because samples 470A-470D are all from the same listing the city feature and the WiFi feature remain the same over all samples, while the days until expiration feature and the price feature change over the sampling period.

Sample 470A was recorded before the transaction request was received and accepted 420 thus a training label of 1 is applied. Sample 470A was recorded on October 4^{th}, 20 days before the expiration date 400, thus the days until expiration feature has a value of 20. In this example, the price of the listing on October 4^{th} was $120, thus the price feature has a value of 120. In sample 470B, the manager has reduced the price to $100 and a week has passed since sample 470A was recorded. Therefore, the values for the days until expiration feature and the price feature have changed to reflect the changes in the listing features. The price of $100 remains constant in the days between the sample 470B and sample 470C. Sample 470C was recorded on the request received and accepted date 420, indicating that the price at which the request was received was $100. Note that this price differs from the original price of $120 for sample 470A.

This difference in prices (and potentially other features) introduces a causality issue because it is unknown whether lowering the price was the causal factor in inducing a client to submit a transaction request for the listing. For example, if a transaction request would not been received at a price of $120 but was later received when the price was lowered to $80, the training label of 1 for the training data sample for dates where the price was $120 would indicate a positive result for feature values (e.g., price $120) that may not have caused the receipt of a transaction request if the price had remained at $120 until expiration.

The pricing module 213 may handle these types of causalities differently depending on the embodiment. In some embodiments, a sample is thrown out if it differs substantially (based on number of differing features between samples, a maximum difference threshold, or another metric) from the sample recorded on the receipt date 420 of the transaction request. In another embodiment, a sample is given less weight based on how much it differs from the sample recorded on the request received date (for example a label of 0.5 may be given). In yet another embodiment, additional features such as a “days until request” or a “price at which the client request was received” feature may be added to the feature vector to reflect differences in sample contributions to the demand function 300. In some cases, these samples with differing features are given full weight for the purpose of simplifying the data labeling process or because they are assumed to have a minimal effect on the demand prediction model. In another embodiment, the average, median, or other measure of the distribution of prices between the initial listing date 410 and the request received date 420 is a separate feature.

III.C.3 Manager Option Training Data Storage

FIG. 5B illustrates an example table for storing the manager option training data by the pricing module 213 in accordance with one embodiment. For the purpose of example, the table 520 represents training data taken from a single listing on an accommodation system. A complete set of training data would include data from many listings. Although only three features are shown in the example table many more features may be included in the manager option function 303. Booked night indicates that dates that this particular listing was successfully booked by a guest of the accommodation system. On each booked night the price is slightly different, as the host has adjusted the prices over the last few days. Because these nights have been successfully booked and the host has approved the listed price the first four data rows receive a positive training label. The system assumed that the host considers these prices acceptable after specifying the prices.

Negative samples for the manager option function 303 are randomly generated by the pricing module 213 to match the number of positive samples for each listing in the set of training data. In this case, because there are four positively labeled samples, four negative samples are generated. In some embodiments each negative sample is given a random value for price within a range from zero to the lowest price set by the manager. In this example 520, the lowest price set by the host is $90. Thus, the four negative samples have prices between $0 and $90. In other embodiments, the prices are evenly distributed between $0 and the lowest price set by the manager. One of skill in the art will understand that any suitable price distribution strategy may be used.

The training data for the manager option function 303 may include features, other than price, that are time-variable. Because the generated negative samples have no associated date, features associated with the date of a particular listing may also be generated based off of data from the positive samples. For example, a generated negative sample may list the average host rating instead of the host rating at the time the listing was booked. This is illustrated in FIG. 5B, as all of the negative samples have the average rating while the positive samples have slightly varying host ratings. Instead of generating the same value for every negative sample, the pricing module 213 may fit a distribution to the values of the particular feature and choose random values of the feature based off of the distribution of values of the positive samples.

III.D Feature Models

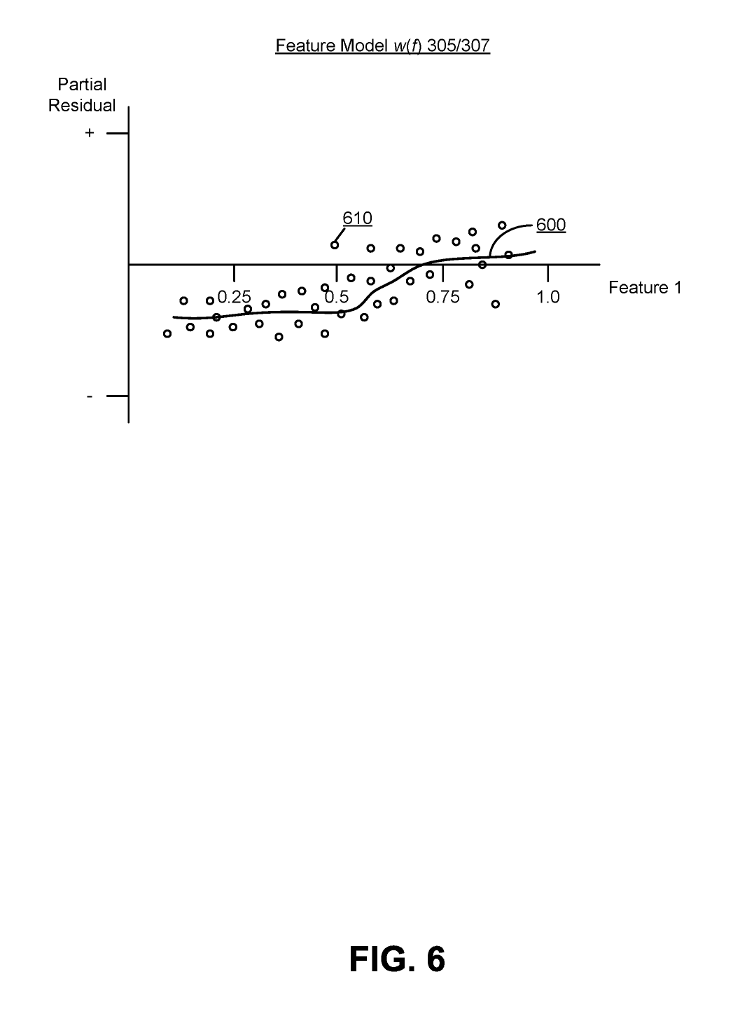

FIG. 6 illustrates a feature model w(f) in accordance with one embodiment. FIG. 6 displays a feature model 305 relating the value of feature 1 to a weight in the demand function 300. A statistical model 600 is fit to the training data points 610, which are the partial residuals between the demand model 300 output D(f) and the corresponding feature value f for an individual sample. Each iteration of the training process changes the residuals and the statistical model 600 is fitted to the data. The algorithms, such as stochastic gradient descent and the backfitting algorithm seek to minimize the partial residuals between the statistical models 600 for all features in the demand model 300. Upon iterating through the training data set the statistical models 600 converge to the feature models 305 or 307 that output a weight for each given feature value. Many statistical methods may be used to fit the data including B-Splines, cubic splines, any type of regression, Kronecker or Dirac delta functions (for categorical and binary data), or any combinations of these methods. Administrators of the online system 111 may configure the feature models 305 and 307 in order to best represent the data. After fitting, feature models 305 and 307 will have weight values between −1 and 1 for full range of feature values. In some embodiments, the feature values are normalized to restrict the range to between 0 and 1. If the feature is categorical or binary the statistical model 600 may simply be a mapping from the feature category to a weight value, or based on a transformation of the categorical data into a scale designed for use in determining the weight.

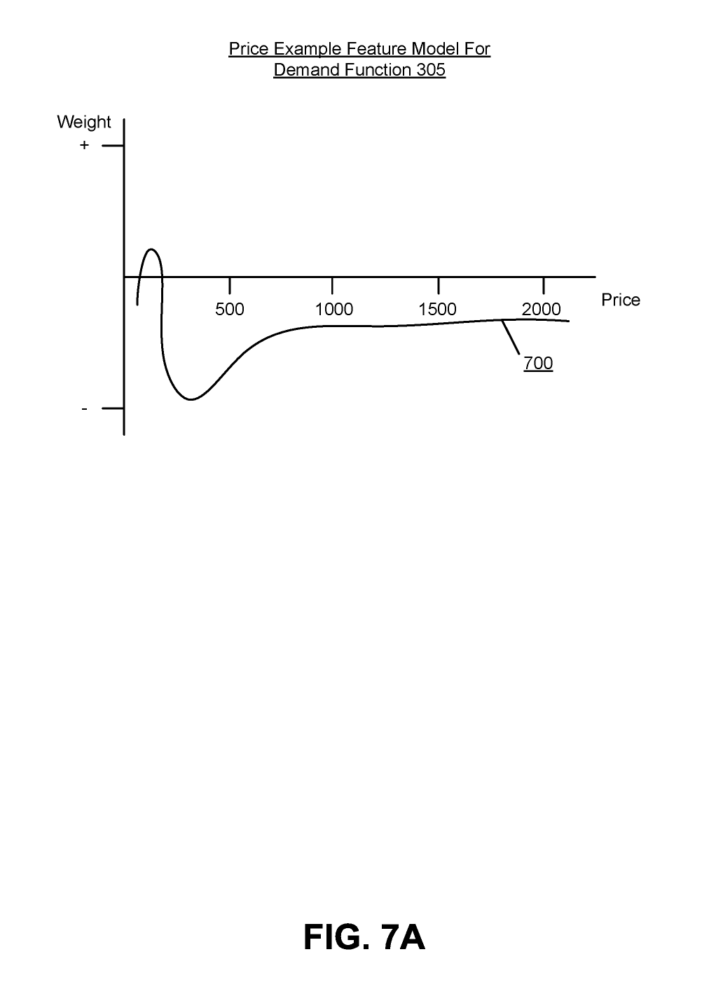

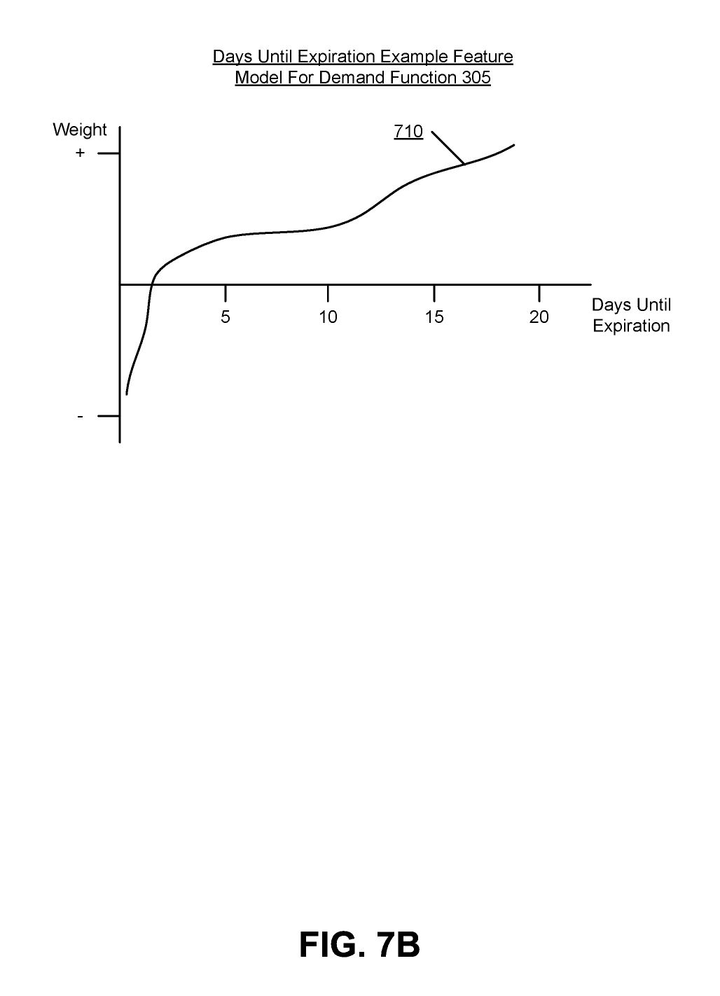

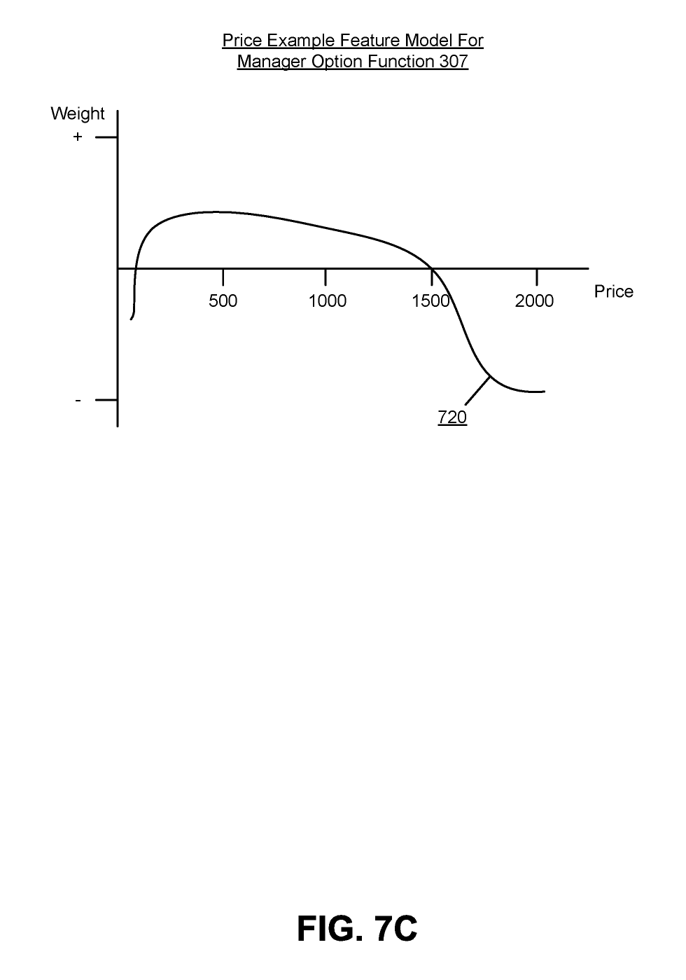

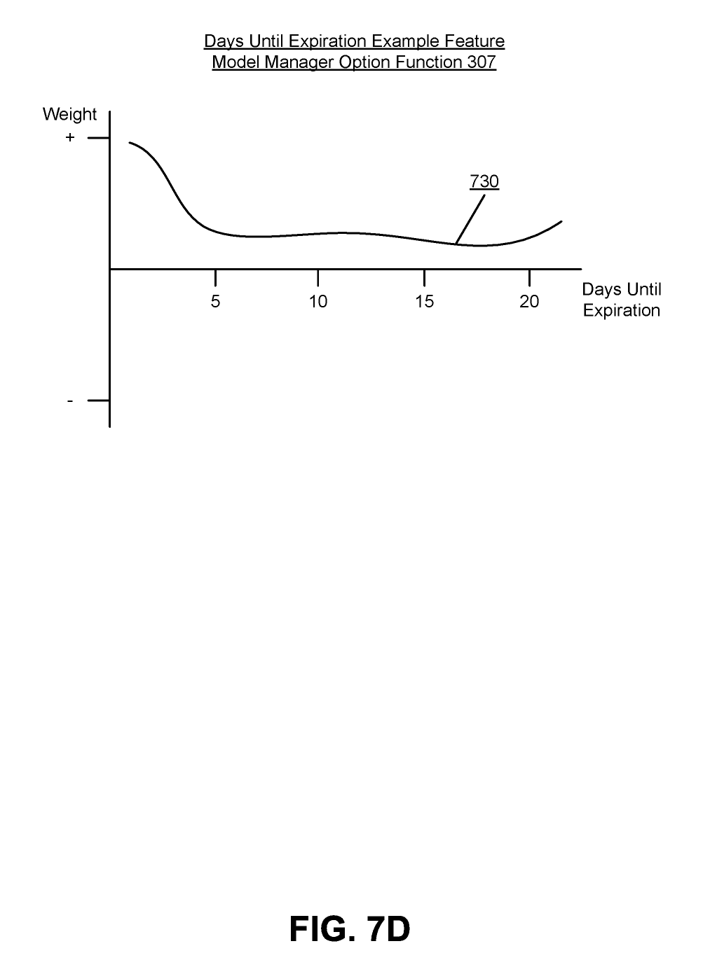

FIGS. 7A-7B illustrate example feature models 305 in accordance with one embodiment. FIG. 7A illustrates an example of what a feature model 305 for a price feature might be with a typical set of demand training data. In this case, the statistical model 700 is typical of a spline fit for price data. Based on the statistical model, the price has a negative effect on demand for very cheap listings (possibly because clients are concerned about being scammed), at cheap but reasonable price levels the price has a positive effect on the demand for a listing. As the price increases, the effect on demand becomes increasingly negative until a certain point where clients at that price level have more elastic spending habits and the price feature has a less negative effect on the demand.

FIG. 7B illustrates what a typical feature model 305 for a “days before expiration” feature with a typical set of demand training data. The statistical model 710 used in this case indicates that the earlier a listing is posted before its expiration date the more likely demand will be high for that listing. Either of these example feature models 305 may vary from typical results and are used herein only as examples to illustrate the functionality of a feature model 305 in the context of the online system 111.

FIGS. 7C-7D illustrate example manager option models in accordance with one embodiment. FIG. 7C illustrates an example of what a feature model 307 for a price feature might be in a typical set of manager option training data. Instead of being negatively correlated with price, likelihood of acceptance is positively correlated with price (managers prefer higher prices for their listings) until a point at which prices become unreasonable and the correlation becomes negative.

FIG. 7D illustrates and example of what a feature model 307 for a “days until expiration feature” might be in a typical set of manager option training data. In this example, the days until expiration feature has a low impact on the manager option until less the 5 days until expiration. At that point, the feature becomes more positively correlated with a manager accepting a price tip because the closer the listing is to expiration the more likely the manager will be susceptible to advice as the listing has had difficulty selling.

III.E Likelihood Model

FIG. 8A illustrates a demand likelihood model 310 used by the pricing module 213 in accordance with one embodiment. Once the pricing module 213 has trained the feature models 305, the pricing module 213 may use a set of feature vectors f for a number of samples of training data, and output an estimated demand D(f) for each of the samples using the demand function 300. To train the likelihood model 310, the pricing module 213 fits a likelihood function 800 to the labeled values for the estimated demands D(f). The likelihood function 800 is a function that solves the binary classification problem of determining the likelihood that a feature vector f has a positive label given D(f), otherwise stated as the likelihood a given sample received a transaction request before expiration of the time-expiring inventory. In FIG. 8, negative labels are represented with a white circle 810 while positive labels are represented by a black circle 820. The likelihood function 800 approximates the likelihood of a dot being black based on the estimated demands for the samples.

In some embodiments, a Platt scaling algorithm is used as the likelihood function 800. The Platt scaling algorithm applied to the demand function would be of the form:

P(D(f))=(1+exp(αD(f)+β))⁻¹

Where α and β are learned constants. A loss function, such as a Hinge-loss function or another similar technique, is used to train the Platt scaling algorithm using the maximum likelihood method so that it best solves this binary classification problem.

Once the pricing module 213 has trained the likelihood function 800, the likelihood module 310 can receive as input an estimated demand D(f), and output a likelihood that a time-expiring inventory will receive a transaction request before expiration P(D(f)).

FIG. 8B illustrates a manager option likelihood model 315 used by the pricing module 213 in accordance with one embodiment. The manager option likelihood model 315 is trained using the same process as described above in relation to the demand likelihood model 310, with the only differences being the use of the manager option function 303 A(f) for the creation of data points, the use of separate training data, and the difference in output.

III.F Demand Pricing Model and Manager Option Pricing Model

FIGS. 9A-9C illustrate the process of creating the demand pricing model 320 for a listing in accordance with one embodiment. After both the demand function 300 (including feature models 305) and the demand likelihood model 310 (including likelihood function 800) have been trained using the samples of training data, the pricing module 213 has the capability to convert any feature vector f to a likelihood of receiving a transaction request P(D(f)).

As introduced above, to provide the likelihood of receiving a transaction request within a range of test prices, the pricing module 213 creates modified feature vectors with price feature values equal to a set of test prices (including the current price of the listing) and the values of the remaining features remaining unchanged. The pricing module 213 then determines test demand estimate and corresponding test likelihood of receiving a transaction request for each modified feature vector.

The pricing module 213 then processes the test prices and corresponding test likelihoods of receiving a transaction request to identify a price that meets a goal of the manager or requester of the information. In one embodiment, this is accomplished by fitting a function to the test price and likelihood data points to create a smooth monotonically decreasing demand model 320. This process is illustrated in FIGS. 9A-9B.

In FIG. 9A the value of the price feature and the likelihood of receiving a transaction request for a time-expiring inventory is plotted. Data point 900 represents the current likelihood of the subject listing receiving a transaction request at its current price. Minimum 915 and maximum price 905 indicate the upper and lower limits of test prices in the demand model 320. These maximum 905 and minimum 915 limits may be set by the manager of the listing or generated by the pricing module 213 to confine the model to a reasonable set of price values. Alternatively a separate minimum and maximum maybe give provided by the user and by the pricing module 213. In embodiments, where there are two sets of the minima and maxima the minimum and maximum specified by the host takes priority over the minimum and maximum specified by the pricing module 213.

The pricing module 213 then creates test data points 910 by incrementing the value of the price feature by price interval 920 positively and/or negatively. Price interval 920 may be an amount or a proportion of the original value of the price feature for the subject listing. In some embodiments, there are different positive and negative price intervals.

The pricing module 213 continues to increment the value of the price feature by the price interval in either direction of the original price. This process continues until a threshold range of test prices are covered or a threshold number of data points are generated, depending on the embodiment. These test prices may, for example, be as high/low as twice/half the current price or higher/lower. Once enough test prices have been generated the data points are fit with price function 930 as illustrated in FIG. 9C. Any function may be used to fit the generated price versus likelihood data. In one embodiment, the price function 930 is a Weibull distribution.

FIGS. 9D-9F illustrate the process of creating the manager option model 325 for a listing in accordance with one embodiment. After both the manager option function 303 (including feature models 307) and the manager option likelihood model 315 (including likelihood function 830) have been trained using the samples of training data, the pricing module 213 has the capability to convert any feature vector f to a likelihood of a manager accepting a price tip P(A(f)). The manager option model 325 is created in the same way as the demand model 320. First an initial data point 975 is generated for the listing. Then test data points 980 are generated at price intervals 925 away from the initial price. Instead of the monotonically decreasing function that is typically fit to the demand pricing model 320, the manager option pricing model 325 is typically a monotonically increasing function. This is intuitive as a manager is more likely to prefer a higher price for a listing than a lower price because, assuming the listing is sold before expiration, it is often equated with higher overall revenue.

### IV. Monte Carlo Pricing Model

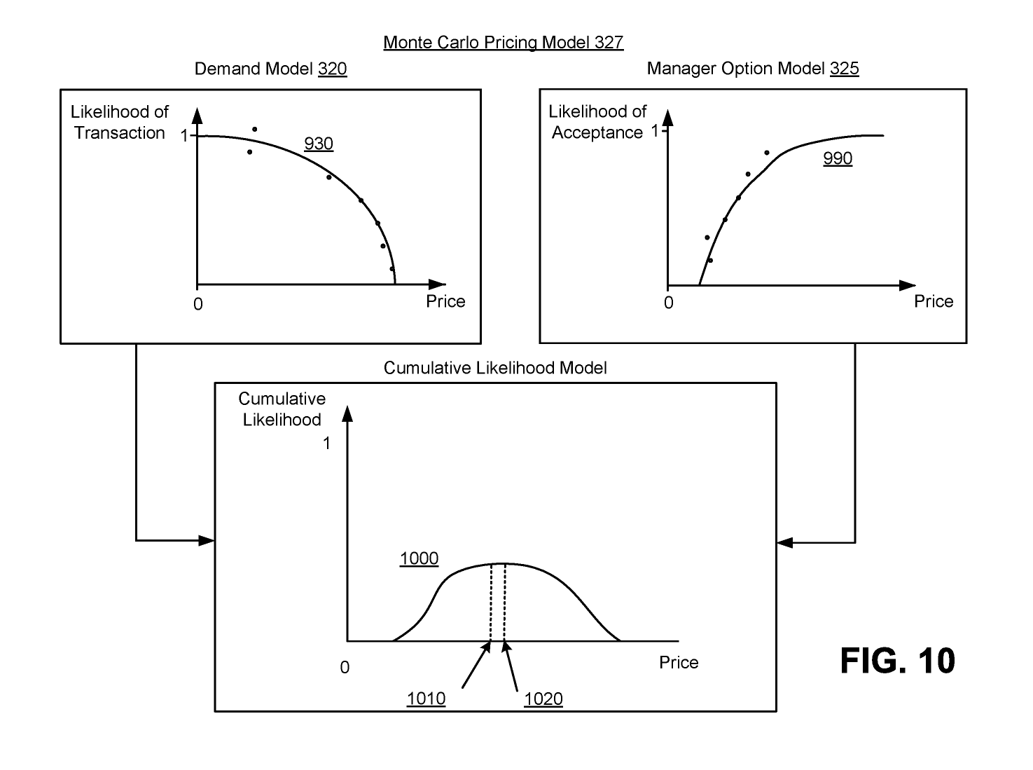

FIG. 10 illustrates the creation of the Monte Carlo pricing model 327 for a listing in accordance with one embodiment. The term Monte Carlo pricing model 327 refers to the usage of both the demand pricing model 320 and the manager option pricing model 325, which are each likelihood distributions to generate a price tip for a listing that is likely to be accepted by the manager of that listing at a price that is likely to result in the listing receiving a transaction request. In one embodiment, Monte Carlo pricing model 327 can be described by the following equation:

$${p}_{T} = \frac{{\sum }_{i = M i n}^{Ma x} {p}_{i} \cdot {{P}_{d} ( {p}_{i} )}^{k} \cdot {P}_{m} ( {p}_{i} )}{{\sum }_{i = M i n}^{Ma x} {{P}_{d} ( {p}_{i} )}^{k} \cdot {P}_{m} ( {p}_{i} )}$$

Where p_{T} is the value of the price tip, pᵢ is a test price, P_{d} (pᵢ) is the likelihood of receiving a transaction request at the test price, Pₘ(pᵢ) is the likelihood of the manager accepting a price tip at the test price, and k is a scaling power.

In this way, the Monte Carlo pricing model 327 can be conceptualized as determining the center of mass of a discrete function defining the overall likelihood of a successful price tip. P_{d} (pᵢ) is the output of the demand model 320 at a test price and Pₘ(pⱼ) is the output of the manager option model 325 at a test price. The parameter k allows the model to weight either the demand pricing model 320 or the manager option pricing model as relatively more important to the overall Monto Carlo pricing model 327. For example, if a host of an accommodation would prefer to have their listing booked every day the importance of the demand model is increased as the host will be willing to accept lower prices for the sake of consistency. In some embodiments, the online system 111 may allow the manager to specify the relative importance of the demand pricing model 320 and the manager option pricing model. This may be accomplished directly by exposing the value of k to the manager or by providing a set of frequency options to the user where each option correspond to a particular value of k. For example, in an accommodation system the options might be posed as: “Would you like to host your listing occasionally, frequently, or as often as possible?” Each subsequent option would then correspond to a different and increasing value of k.

Once the pricing module 213 determines the price tip, p_{T}, using the Monte Carlo pricing model 327 the price tip is presented to the manager of the listing who is given the option to accept or deny the price tip. To determine the price tip, the Monte Carlo pricing model 327 may be conceptualized as finding the center of mass of a cumulative likelihood model 1000. The cumulative likelihood model 1000 is the weighted (by k) product of the demand model 320 and the manager option model 325. The maximum likelihood price 1020 may be used as the price tip. However, the center of mass 1010 (p_{T}) of the cumulative likelihood model 1000 is often a better estimate and it may be used instead.

### V. Agility Pricing Model

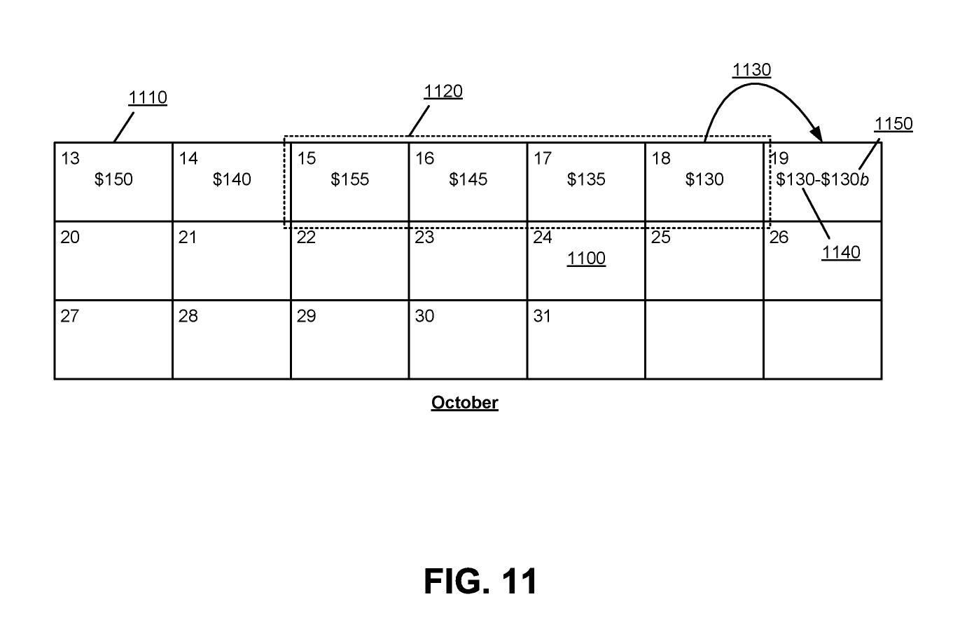

FIG. 11 is a conceptual illustration of an agility pricing model in accordance with one embodiment. An agility pricing model is a model that allows for the correction of price tips over a short period of time that would not be possible by simply retraining the demand pricing model 320 and manager option pricing model 325. The agility pricing model applies a learning rate to a predetermined window of time that a listing has not been booked. The fact that the listing has not been booked for the duration of this window indicates that the price tips (or the manager's pricing strategy) during the time window have been too high in price. The agility pricing model can be used to determine an adjusted price after a series of manager selected prices intermingled with prices set by a manager accepting a price tip. The agility model takes some statistical measure of the prices in the time window and subtracts a learning constant proportional to that value. For example, the minimum price during four day time window may be calculated and the price tip for the following day may be that minimum four day price minus the learning constant. In other embodiments, median, mode, or average price of the prices included in the time window are used.

FIG. 11 depicts a calendar for a listing that has an expiration date 1100 on October 24. On October 13 the price tip for the listing is $150, which then falls to $140 on October 14, and $155 on October 15, etc. To determine the price tip for October 19, the pricing module 213 calculates 1130 the minimum price 1140 over the time window 1120, which, in this case, is $130. The minimum price 1140 is then adjusted downwards by a learning amount 1150 proportional to the minimum price 1140 based on learning constant b. In some embodiments, an average of the prices in the time window are used instead of the minimum.

In some embodiments, instead of subtracting the learning amount 1150 from the minimum price 1140 the pricing module 213 may use the Monte Carlo pricing model 327 to estimate a pricing tip, which is then adjusted by a learning amount 1150 based on a time window 1120 or recent prices for the listing.

### VI. Additional Considerations

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. In one embodiment, a software module is implemented with a computer program product comprising a persistent computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, an example of which is set forth in the following claims.

What is claimed is:

1. A computer-executed method comprising:
receiving, at an online computing system, a first feature vector and a second feature vector for a subject listing, the subject listing comprising a time-expiring inventory available to be booked by one of a plurality of clients of the online computing system and managed by a manager, the first feature vector and the second feature vector each comprising a plurality of features of the listing including a price feature indicating a current price of the time-expiring inventory;
inputting the first feature vector into a demand function to generate a demand estimate that is a numerical representation of a likelihood that the time-expiring inventory will receive a transaction request from one of the clients before the time-expiring inventory expires;
inputting the second feature vector into a manager option function to generate an acceptance estimate that is a numerical representation of a likelihood that the manager of the time-expiring inventory is willing to offer the time expiring inventory to clients at the current price; and
storing the demand estimate and the acceptance estimate.

2. The computer-executed method of claim 1:
wherein the demand function comprises a plurality of demand feature models, each feature in the first feature vector associated with one of the demand feature models; and
wherein the manager option function comprises a plurality of manager option feature models, each feature in the second feature vector associated with one of the manager option feature models.

3. The computer-executed method of claim 2:
wherein the demand function comprises a generalized additive model that includes the demand feature models; and
wherein the manager option function comprises a generalized additive model that includes the manager option feature models.

4. The computer-executed method of claim 1:
wherein the manager option function was trained on training data where each sample from the training data comprises a binary label and a training feature vector of a training time-expiring inventory, the positive label representing whether a training time-expiring inventory was priced and received a transaction request before the expiration of the training time-expiring inventory, the training feature vector having a plurality of features of the training listing associated with the training time-expiring inventory.

5. The computer-executed method of claim 4:
wherein the feature vector further comprises a time period until expiration feature indicating a duration until the time-expiring inventory expires.

6. The computer-executed method of claim 5:
wherein the training data having a negative binary label have generated training feature vectors, the generated training feature vectors having a randomly generated price feature.

7. The computer-executed method of claim 6:
wherein the randomly generated price feature is randomly generated between the lowest price of time-expiring inventory and zero.

8. The computer-executed method of claim 1 further comprising:
generating a set of test prices that are greater or less than the price of the time-expiring inventory
inputting into the demand function, for each of the test prices in the set, a modified version of the first feature vector that replaces the current price with the test price in order to generate a test demand estimate;
inputting into the manager option function, for each of the test prices in the set, a modified version of the second feature vector that replaces the current price with the test price in order to generate a test acceptance estimate;
generating a set of demand estimates comprised of the test demand estimates generated based on the test prices and the demand estimate generated based on the current price; and
generating a set of acceptance estimates comprised of the test acceptance estimates generated based on the test prices and the acceptance estimate generated based on the current price.

9. The computer-executed method of claim 8 further comprising:
inputting the set of demand estimates into a demand likelihood model to generate a set of request likelihoods, each request likelihood representing a likelihood that the time-expiring inventory associated with one of the demand estimates will receive a transaction request at each of the test prices; and
inputting the set of acceptance estimate into a manager option likelihood model to generate a set of manager option likelihoods, each manager option likelihood representing a likelihood that the manager of the time-expiring inventory associated with associated with one of the acceptance estimates will accept a price tip at each of the test prices.

10. The computer-executed method of claim 9 further comprising:
fitting a demand pricing model based on a first set of data points, each data point in the first set comprising one of the request likelihoods from the set and the test price used to generate the demand estimate that was used to generate the request likelihood; the function representing a range of prices for the time-expiring inventory at different request likelihoods; and
fitting a manager option pricing model based on a second set of data points, each data point in the second set comprising one of the manager option likelihoods from the set and the test price used to generate the acceptance estimate that was used to generate the manager option likelihood; the function representing a range of prices for the time-expiring inventory at different manager option likelihoods.

11. The computer-executed method of claim 10 wherein determining the price tip further comprises creating a Monte Carlo pricing model using the demand model and the manager option model.

12. The computer-executed method of claim 11, wherein the Monte Carlo pricing model determines a center of mass of a product of the demand model and the manager option model.

13. The computer-executed method of claim 12, wherein the product is a weighted product.

14. The computer-executed method of claim 11, wherein the Monte Carlo pricing model is defined by:
$${p}_{T} = \frac{{\sum }_{i = M i n}^{Ma x} {p}_{i} \cdot {{P}_{d} ( {p}_{i} )}^{k} \cdot {P}_{m} ( {p}_{i} )}{{\sum }_{i = M i n}^{Ma x} {{P}_{d} ( {p}_{i} )}^{k} \cdot {P}_{m} ( {p}_{i} )}$$
where p_{T} is the value of the price tip, pᵢ is a test price, P_{d} (pᵢ) is the likelihood of receiving a transaction request at the test price, Pₘ(pᵢ) is the likelihood of the manager accepting a price tip at the test price, and k is a scaling power.

15. The computer-executed method of claim 11, further comprising modifying the price tip based on an agility pricing model.

16. The computer-executed method of claim 15, wherein the agility pricing model further comprises:
modifying the price tip based on a minimum set price over a predefined time window preceding a current time by subtracting the minimum set price multiplied by a learning rate from the price tip.
